(19) United States
(12) Patent Application Publication
(10) Pub. No.: US 2026/0238994 A1
(43) Pub. Date: Aug. 13, 2026

(54) WIRELESS COMMUNICATION METHOD AND COMMUNICATION DEVICE

(71) Applicant: GUANGDONG OPPO MOBILE TELECOMMUNICATIONS CORP., LTD., Dongguan (CN)

(72) Inventors: Ning GAO, Dongguan (CN); Chaoming LUO, Dongguan (CN); Yapu LI, Dongguan (CN); Liuming LU, Dongguan (CN); Jun ZHANG, Dongguan (CN)

(73) Assignee: GUANGDONG OPPO MOBILE TELECOMMUNICATIONS CORP., LTD., Dongguan (CN)

(21) Appl. No.: 19/640,273

(22) Filed: Apr. 6, 2026

Related U.S. Application Data
(63) Continuation of application No. PCT/CN2023/138539, filed on Dec. 13, 2023.

(51) Int. Cl. H04W 8/24

(52) U.S. Cl. CPC H04W 8/24

(57) ABSTRACT

Provided are a wireless communication method and a communication device. The method comprises: a first device sends first indication information to a second device, wherein the first indication information is used for indicating capabilities information of a target device, the target device comprises the first device and/or a third device, and the capabilities information comprises one or more of the following information of the target device: a multi-AP coordination capability; a secondary channel access capability; a capability of priority channel access; a support condition of a link adaptation function; a support condition of a relay function; a DRU-based transmission capability; a mobility capability; a power supply mode; a preemption-related capability; a capability to support a target protocol; a roaming enhancing capability; a support condition of a non-trigger frame-based TXOP sharing function; an energy saving capability; a support condition of an A-MPDU length passive adjustment function.

### CROSS-REFERENCE TO RELATED APPLICATIONS

This application is a continuation of International Application No. PCT/CN2023/138539, filed on Dec. 13, 2023, the disclosure of which is hereby incorporated by reference in its entirety.

### TECHNICAL FIELD

This application relates to the field of communications technologies, and more specifically, to a wireless communication method and a communications device.

### BACKGROUND

With the development of technologies, capabilities of communications devices are becoming increasingly diverse. However, techniques for indicating capabilities information cannot keep pace with technological development, making it difficult to well apply some communication technologies in practical communication scenarios.

### SUMMARY

This application provides a wireless communication method and a communications device. Various aspects of this application are described below.

According to a first aspect, there is provided a wireless communication method. The wireless communication method includes: transmitting, by a first device, first indication information to a second device, where the first indication information is used to indicate capabilities information of a target device, the target device includes the first device and/or a third device, and the capabilities information includes one or more of following information of the target device: a capability of multi-access point (AP) coordination; a capability of secondary channel access; a capability of priority channel access; a support status of a link adaptation function; a support status of a relay function; a capability of transmission based on a distributed resource unit (DRU); a mobility capability; a power supply mode; a capability related to preemption; a capability to support a target protocol; a capability of enhanced roaming; a support status of a transmission opportunity (TXOP) sharing function based on a non-triggered frame; a power-saving capability; a support status of an aggregation medium access control protocol data unit (A-MPDU) length passive adjustment function; a support status of a 320 MHz frequency aggregation physical layer protocol data unit (PPDU); a support status of a resource unit (RU) adaptation function; a support status of a replication function; a capability of inserted PPDU-based communication; or a capability of communication in a frequency band above 45 GHz.

According to a second aspect, there is provided a wireless communication method. The wireless communication method includes: receiving, by a second device, first indication information transmitted by a first device, where the first indication information is used to indicate capabilities information of a target device, the target device includes the first device and/or a third device, and the capabilities information includes one or more of following information of the target device: a capability of multi-AP coordination; a capability of secondary channel access; a capability of priority channel access; a support status of a link adaptation function; a support status of a relay function; a capability of transmission based on a DRU; a mobility capability; a power supply mode; a capability related to preemption; a capability to support a target protocol; a capability of enhanced roaming; a support status of a TXOP sharing function based on a non-triggered frame; a power-saving capability; a support status of an A-MPDU length passive adjustment function; a support status of a 320 MHz frequency aggregation PPDU; a support status of an RU adaptation function; a support status of a replication function; a capability of inserted PPDU-based communication; or a capability of communication in a frequency band above 45 GHz.

According to a third aspect, there is provided a communications device. The communications device is a first device, and the communications device includes: a transmitting unit, configured to transmit first indication information to a second device, where the first indication information is used to indicate capabilities information of a target device, the target device includes the first device and/or a third device, and the capabilities information includes one or more of following information of the target device: a capability of multi-AP coordination; a capability of secondary channel access; a capability of priority channel access; a support status of a link adaptation function; a support status of a relay function; a capability of transmission based on a DRU; a mobility capability; a power supply mode; a capability related to preemption; a capability to support a target protocol; a capability of enhanced roaming; a support status of a TXOP sharing function based on a non-triggered frame; a power-saving capability; a support status of an A-MPDU length passive adjustment function; a support status of a 320 MHz frequency aggregation PPDU; a support status of an RU adaptation function; a support status of a replication function; a capability of inserted PPDU-based communication; or a capability of communication in a frequency band above 45 GHz.

According to a fourth aspect, there is provided a communications device. The communications device is a second device, and the communications device includes: a receiving unit, configured to receive first indication information transmitted by a first device, where the first indication information is used to indicate capabilities information of a target device, the target device includes the first device and/or a third device, and the capabilities information includes one or more of following information of the target device: a capability of multi-AP coordination; a capability of secondary channel access; a capability of priority channel access; a support status of a link adaptation function; a support status of a relay function; a capability of transmission based on a DRU; a mobility capability; a power supply mode; a capability related to preemption; a capability to support a target protocol; a capability of enhanced roaming; a support status of a TXOP sharing function based on a non-triggered frame; a power-saving capability; a support status of an A-MPDU length passive adjustment function; a support status of a 320 MHz frequency aggregation PPDU; a support status of an RU adaptation function; a support status of a replication function; a capability of inserted PPDU-based communication; or a capability of communication in a frequency band above 45 GHZ.

According to a fifth aspect, a communications device is provided. The communications device includes a processor and a memory. The memory is configured to store one or more computer programs. The processor is configured to invoke the computer program in the memory, to cause the communications device to perform some or all of the steps of a method according to the foregoing aspects.

According to a sixth aspect, an embodiment of this application provides a communications system, and the system includes the foregoing communications device. In another possible design, the system may further include another device that interacts with the communications device in the solution provided in embodiments of this application.

According to a seventh aspect, an embodiment of this application provides a computer-readable storage medium. The computer-readable storage medium stores a computer program, and the computer program causes a communications device to perform some or all of the steps in a method according to the foregoing aspects.

According to an eighth aspect, an embodiment of this application provides a computer program product. The computer program product includes a non-transitory computer-readable storage medium storing a computer program, and the computer program is operable to cause a communications device to perform some or all of the steps of a method according to the foregoing aspects. In some implementations, the computer program product may be a software installation package.

According to a ninth aspect, an embodiment of this application provides a chip, where the chip includes a memory and a processor, and the processor may invoke a computer program from the memory and run the computer program, to implement some or all of steps described in a method according to each of the foregoing aspects.

### BRIEF DESCRIPTION OF DRAWINGS

FIG. 1 is a schematic diagram of a wireless communications system to which embodiments of this application are applicable.

FIG. 2A is an example diagram of a capability discovery process based on passive scanning.

FIG. 2B is an example diagram of a capability discovery process based on active scanning.

FIG. 2C is an example diagram of a capability discovery process based on association.

FIG. 2D is an example diagram of a capability discovery process based on reassociation.

FIG. 2E is an example diagram of a capability discovery process based on authentication.

FIG. 3A is an example diagram of a format of a neighbor report element.

FIG. 3B is an example diagram of a format of a capabilities information field in a neighbor report element.

FIG. 4 is an example diagram of a format of a reduced neighbor report (RNR) element.

FIG. 5 is a schematic flowchart of a wireless communication method according to an embodiment of this application.

FIG. 6 is a schematic diagram of a format of a secondary channel operation element according to an embodiment of this application.

FIG. 7A is an example diagram of a format of a first capabilities element according to an embodiment of this application.

FIG. 7B is a schematic diagram of a format of a UHR MAC capabilities information field.

FIG. 7C is a schematic diagram of a format of a UHR PHY capabilities information field.

FIG. 8 is a schematic diagram of a format of a neighbor report element according to an embodiment of this application.

FIG. 9 is a schematic diagram of a format of a reduced neighbor report element according to an embodiment of this application.

FIG. 10 is a schematic structural diagram of a communications device according to an embodiment of this application.

FIG. 11 is a schematic structural diagram of a communications device according to an embodiment of this application.

FIG. 12 is a schematic structural diagram of an apparatus for communication according to an embodiment of this application.

### DESCRIPTION OF EMBODIMENTS

Technical solutions in this application are described below with reference to the accompanying drawings.

### Communications System

The technical solutions in embodiments of this application may be applied to various communications systems, for example, a wireless local area network (WLAN), wireless fidelity in (Wi-Fi), a high performance radio local area network (HIPELAN), a wide area network (WAN), a cellular network, or another communications system. For another example, the technical solutions provided in embodiments of this application may be applied to a communications system using the 802.11 standard. For example, the 802.11 standard includes but is not limited to the 802.11ax standard, the 802.11be standard, a next-generation 802.11 standard, or the like.

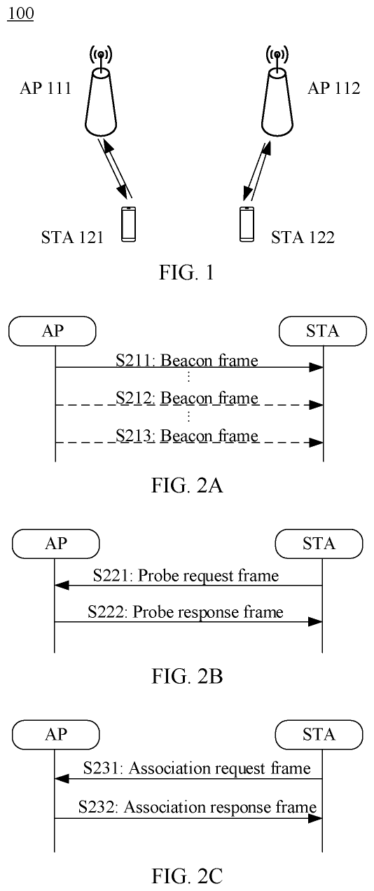

FIG. 1 is a schematic diagram of a communications system to which an embodiment of this application is applied. With reference to FIG. 1, a communications device in the communications system 100 may include an AP 111, an AP 112, a station (STA) 121, and a STA 122, where the STA 121 may access a network through the AP 111, and the STA 122 may access a network through the AP 112.

In some implementations, a STA may establish an association relationship with one or more APs. Then, the STA and the AP that have an association relationship may communicate with each other. With reference to FIG. 1, the AP 111 and the STA 121 may communicate with each other after an association relationship is established therebetween; and the AP 112 and the STA 122 may communicate with each other after an association relationship is established therebetween.

In some implementations, communication in the communications system 100 may be communication between an AP and a non-AP STA, or may be communication between a non-AP STA and another non-AP STA, or communication between a STA and a peer STA, where the peer STA may refer to a device that performs peer-to-peer communication with the STA, for example, the peer STA may be an AP, or may be a non-AP STA.

It should be understood that FIG. 1 exemplarily shows two AP STAs and two non-AP STAs. Alternatively, the communications system 100 may include more AP STAs, or the communications system 100 may include another quantity of non-AP STAs. This is not limited in embodiments of this application.

In addition, the foregoing communications system may be applied to scenarios of multi-device collaboration, for example, a scenario of multi-AP collaboration, a scenario of multi-station collaboration, or the like.

Names of the AP and/or STA are not limited in embodiments of this application. In some scenarios, an AP may also be referred to as an AP STA. In other words, in a sense, the AP is also a STA. In some other scenarios, a STA may also be referred to as a non-AP STA.

In some scenarios, the foregoing communications device may alternatively be a “multi-link device (MLD)”, namely, a device that can perform communication through a plurality of communication links. The plurality of communication links may include communication links of different frequency bands, for example, may include a millimeter-wave frequency band and/or a low frequency band. Generally, if the multi-link device is an AP, the AP may also be referred to as a “multi-link AP”. If the multi-link device is a STA, the STA may also be referred to as a “multi-link STA”.

In embodiments of this application, the AP may be a device in a wireless network. The AP may be a communications entity, for example, a communications server, a router, a switch, a network bridge, or the like; or the AP device may include various forms of macro base stations, micro base stations, relay stations, or the like. Certainly, the AP may alternatively be a chip, a circuit, or a processing system in these various forms of devices, to implement a method and a function in embodiments of this application. The AP device may be applied to a variety of scenarios, for example, a sensor node (for example, a smart water meter, a smart electricity meter, or a smart air detection node) in a smart city, a smart device (for example, a smart camera, a projector, a display screen, a TV, a speaker, a refrigerator, a washing machine, or the like) in a smart home, a node in the Internet of things, an entertainment terminal (for example, a wearable device such as AR or VR), a smart device (for example, a printer, a projector, or the like) in a smart office, a vehicle-to-everything device in the Internet of vehicles, infrastructure (for example, a vending machine, a self-service navigation station in a shopping mall or supermarket, a self-service cashier device, or a self-ordering kiosk) in daily life scenarios, or the like.

In some implementations, a role of the STA in the communications system is not fixed. In some scenarios, the STA may serve as an AP. For example, in a scenario in which a mobile phone is connected to a router, the mobile phone may be a non-AP STA; and in a case that the mobile phone serves as a hotspot for another mobile phone, the mobile phone acts as an AP.

In embodiments of this application, a STA device in embodiments of this application may be a device having a wireless transceiver function, for example, may be a device that supports 802.11 series of protocols and may communicate with an AP or another STA. For example, the STA is any communications device of a user that allows the user to communicate with an AP and then communicate with a WLAN. For example, the STA device is: a user equipment (UE), a mobile station (MS), a mobile terminal (MT), an access terminal, a subscriber unit, a subscriber station, a mobile site, a mobile station, a remote station, a remote terminal, a mobile device, a user terminal, a terminal, a wireless communications device, a user agent, a user apparatus, or the like.

The STA in embodiments of this application may alternatively be a device providing a user with voice/data connectivity, for example, a handheld device, a vehicle-mounted device, or the like having a wireless connection function. For example, the STA is a mobile phone, a tablet computer, a notebook computer, a palmtop computer, a mobile Internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal device in a 5G network, a terminal device in a future evolved public land mobile network (PLMN), or the like. This is not limited in embodiments of this application.

By way of example rather than limitation, in embodiments of this application, the STA device may alternatively be a wearable device. The wearable device may also be referred to as a smart wearable device, and is a general term for wearable devices such as glasses, gloves, watches, clothes, and shoes intelligently designed and developed based on daily wearing by using a wearable technology, for example, a smart watch or smart glasses, and devices that focus on only a specific type of application function and need to cooperate with another device such as a smart phone for use, for example, various smart bracelets and smart jewelries for physical sign monitoring.

In addition, in embodiments of this application, the STA device may alternatively be a terminal device in an Internet of Things (IoT) system. The IoT is an important component of future development of information technologies, and a main technical feature of the IoT is that objects are connected to a network by using a communication technology, to implement an intelligent network of human-computer interconnection and interconnection of things. In embodiments of this application, the IoT technology may implement mass connection, intensive coverage, and terminal power saving by using a narrow band (NB) technology or the like.

In addition, in embodiments of this application, the STA device may be a device in a vehicle-to-everything system. Communication methods in the vehicle-to-everything system are collectively referred to as V2X (where X represents everything). For example, the V2X communication includes: vehicle to vehicle (V2V) communication, vehicle to roadside infrastructure (V2I) communication, vehicle to pedestrian (V2P) communication, vehicle to network (V2N) communication, or the like.

In addition, in embodiments of this application, the STA device may further include sensors such as a smart printer, a train detector, a gas station, or the like. Main functions of the device include: collecting data (some terminal devices), receiving control information and downlink data from an AP device, transmitting an electromagnetic wave, and transmitting data to the AP device.

In addition, the AP device in embodiments of this application may be a device for communication with the STA device. The AP device may be a network device in a wireless local area network. The AP device may be configured to communicate with the STA device through the wireless local area network.

From the perspective of a communication standard supported by an AP, in some implementations, the AP may be a device that supports the 802.11be standard. The AP may alternatively be a device that supports a plurality of current and future WLAN standards of the 802.11 family, such as 802.11ax, 802.11ac, 802.11n, 802.11g, 802.11b, and 802.11a.

From the perspective of a communication standard supported by a STA, in some implementations, the non-AP STA may support the 802.11be standard. The non-AP STA may also support a plurality of current and future wireless local area network (WLAN) standards of an 802.11 family, such as 802.11ax, 802.11ac, 802.11n, 802.11g, 802.11b, and 802.11a.

Frequency bands supported in a WLAN technology are not limited in embodiments of this application. In some implementations, the frequency bands supported in the WLAN technology may include but are not limited to a low frequency band (for example, 2.4 GHZ, 5 GHZ, or 6 GHz) and a high frequency band (for example, 45 GHz or 60 GHz).

It should be understood that specific forms of the STA device and the AP device are not specially limited in embodiments of this application and are merely described as examples

### Capabilities Information

Due to differences in hardware, software, and the like among different communications devices, different communications devices have different capabilities. Generally, corresponding communication processes are required to be performed based on capabilities information of a communications device.

Capabilities information may be included in one or more of following capabilities elements: very high throughput (VHT) capabilities, high-efficiency (HE) capabilities, extremely high throughput (EHT) capabilities. These capabilities elements may be used to indicate capabilities information of respective technologies. For example, the VHT capabilities element may be used to indicate one or more pieces of capabilities information related to the VHT technology.

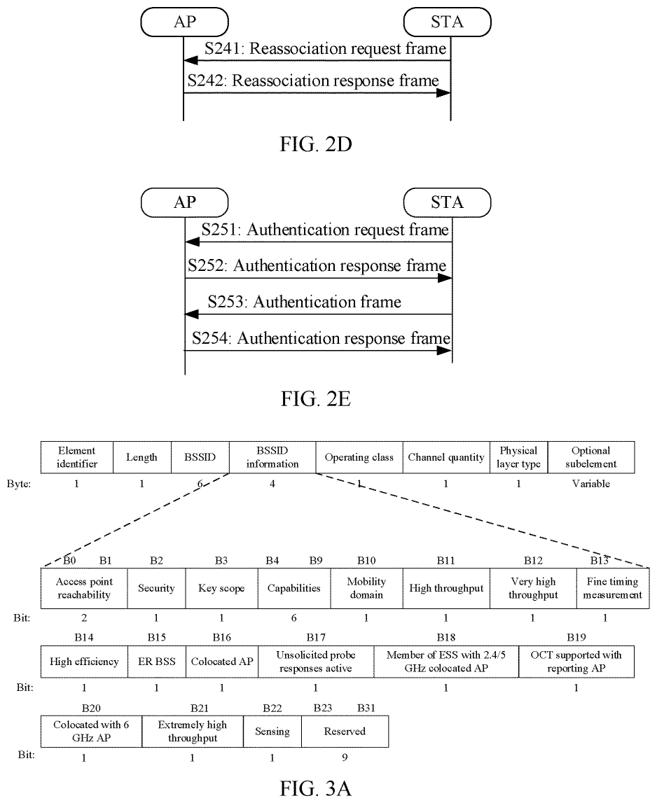

A discovery process of capabilities information is described below with reference to FIG. 2A to FIG. 2E. It may be understood that, FIG. 2A to FIG. 2E are merely examples, and the discovery process of the capabilities information may also be implemented through other processes.

### Passive Scanning

If a STA expects to establish an association and a connection with an AP, the STA may discover the presence of the AP through scanning. In other words, through the scanning process, the STA may obtain information about surrounding wireless networks. Scanning may be classified into passive scanning and active scanning. “Passive scanning” is used as an example below for description.

FIG. 2A is an example diagram of a capability discovery process based on passive scanning. FIG. 2A may include step S211.

In step S211, an AP transmits a beacon frame.

The beacon frame may include basic service set (BSS) basic information. The BSS basic information may include, for example, a BSS identifier (BSSID), and a beacon interval. The beacon frame may further include capabilities information of the AP.

The STA may obtain capabilities information of a corresponding AP by monitoring beacon frames transmitted by surrounding APs.

The AP may periodically broadcast one or more beacon frames. For example, in a case in which a plurality of beacon frames are transmitted, FIG. 2A may further include step S212 and/or step S213.

It may be understood that in the passive scanning process, through the beacon frames, the STA can obtain capabilities information of the AP.

### Active Scanning

As mentioned above, scanning may also be implemented through an “active scanning” process. FIG. 2B is an example diagram of a capability discovery process based on active scanning. FIG. 2B may include step S221 and step S222.

In step S221, a STA transmits a probe request frame on a supported channel.

The probe request frame may be used to probe for surrounding existing wireless networks. The probe request frame may include capabilities information of the STA.

After an AP surrounding the STA receives the probe request frame, if the AP meets requirements, the AP may perform step S222.

It should be noted that a BSS identifier (ID) may be specified in the probe request frame, or no BSS identifier may be specified. If a BSS identifier is specified, an AP corresponding to the BSS identifier may perform S222. If no BSS identifier is specified, all APs that receive the probe request frame may perform step S222.

In step S222, the AP replies with a probe response frame.

The probe response frame may include capabilities information of the AP.

It may be understood that in the active scanning process, through the probe request frame, the AP can obtain the capabilities information of the STA. Through the probe response frame, the STA can obtain the capabilities information of the AP.

### Association

To access a wireless network (for example, a WLAN network) for communication, a STA may establish an association with a specific AP.

FIG. 2C is an example diagram of a capability discovery process based on association. FIG. 2C may include step S231 and step S232.

In step S231, a STA transmits an association request frame to an AP.

The association request frame may carry one or more pieces of capabilities information of the STA, such as a rate, a channel, a quality of service (QoS) capability, and the like supported by the STA.

After receiving the association request frame, the AP may detect a capability reported by the STA, and may further perform step S232.

In step S232, the AP replies to the STA with an association response frame.

The association response frame may be used to notify the STA whether the association with the STA is successful. The association response frame may carry capabilities information of the AP.

It may be understood that in the association process, through the association request frame, the AP can obtain the capabilities information of the STA. Through the association response frame, the STA can obtain the capabilities information of the AP.

### Reassociation

When a STA roams within a same extended service set (ESS), association with another AP may be implemented through a reassociation procedure.

FIG. 2D is an example diagram of a capability discovery process based on reassociation. FIG. 2D may include step S241 and step S242.

In step S241, a STA transmits a reassociation request frame to an AP.

The reassociation request frame may carry an address of a current AP, and may further carry capabilities information of the STA.

After receiving the reassociation request frame, the AP may perform step S242.

In step S242, the AP transmits a reassociation response frame to the STA.

The reassociation response frame may be used to notify the STA whether the association is successful. The reassociation response frame may further carry capabilities information of the AP.

It may be understood that in the reassociation process, through the reassociation request frame, the AP can obtain the capabilities information of the STA. Through the reassociation response frame, the STA can obtain the capabilities information of the AP.

### Authentication

FIG. 2E is an example diagram of a capability discovery process based on authentication. A method illustrated in FIG. 2E may include step S251 to step S254.

In step S251, a STA transmits an authentication request frame to an AP.

After receiving the authentication request frame, the AP may randomly generate a challenge code (challenge), and may further perform step S252.

In step S252, the AP transmits an authentication response frame to the STA.

The authentication response frame may include the challenge code.

After receiving the challenge code, the STA may encrypt the challenge code by using a key of the STA.

In step S253, the STA transmits an authentication frame to the AP.

The authentication frame may include encrypted information, namely, the challenge code encrypted by the STA.

After receiving the encrypted information, the AP may decrypt the encrypted information by using a key of the AP to determine an authentication result. If the decrypted challenge code is still the challenge code generated by the AP, the authentication result indicates that the authentication is successful; and if the decrypted challenge code is not the challenge code generated by the AP, the authentication result indicates that the authentication has failed.

In step S254, the AP transmits an authentication response frame to the STA.

The authentication response frame may include the authentication result.

It should be noted that both the authentication request frame and the authentication response frame are specific types of authentication frames. Authentication frames may be used to carry capabilities information of a device. For example, the authentication request frame may be used to carry capabilities information of the STA. For another example, the authentication response frame may carry capabilities information of the AP.

It may be understood that based on the above process, a device may transmit capabilities information of itself. In some embodiments, a device may transmit capabilities information of another device. How a device transmits capabilities information of another device by using a neighbor report element and a reduced neighbor report element is described below.

### Neighbor Report Element

The neighbor report element may carry descriptive information about another AP (for example, a neighbor AP) near an AP. Based on the neighbor report element, a non-AP STA may learn a status of another AP around it to facilitate a handover.

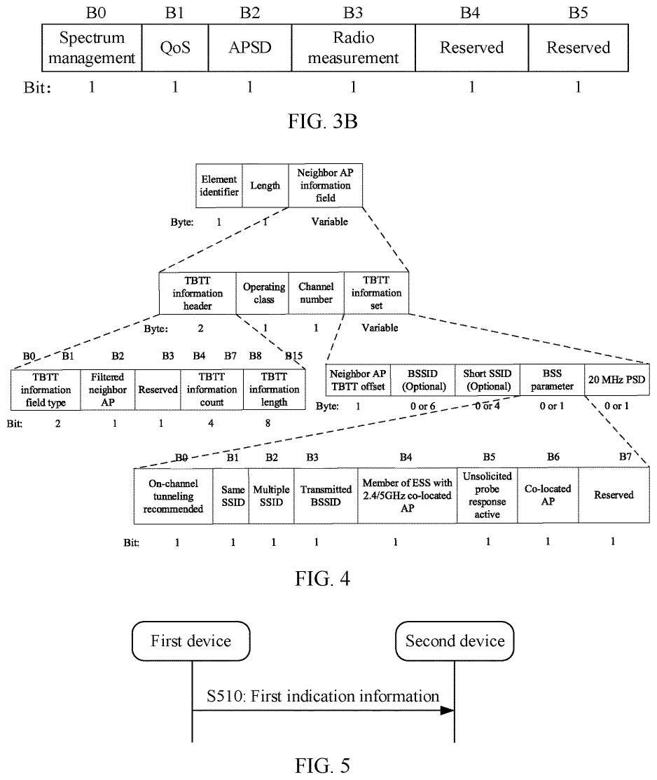

FIG. 3A is an example diagram of a format of the neighbor report element.

As shown in FIG. 3A, the neighbor report element may include one or more of the following fields: an element identifier (element ID) field, a length field, a BSS identifier (BSSID) field, a BSSID information field, an operating class field, a channel quantity (channel number) field, a physical layer type (PHY type) field, or an optional subelement field. Some of these fields are described below.

The element identifier field may be used to indicate an identifier of an element. A value of the element identifier field being 52 may indicate that this element is a neighbor report element.

The length field may be used to indicate a quantity of bytes in the neighbor report element other than the element identifier field and the length field.

The BSSID field may indicate an identifier of a reported BSS. In other words, the BSSID may be used to indicate an AP reported by this element (hereinafter referred to as the reported AP). All fields following the BSSID field in the neighbor report element may be related to the BSS indicated by the BSSID field.

The BSSID information may include one or more of the following fields: an access point reachability (AP reachability) field, a security field, a key scope field, a capabilities field, a mobility domain field, a high throughput (HT) field, a very high throughput (VHT) field, a fine timing measurement (FTM) field, a high efficiency (HE) field, an extended range BSS (ER BSS) field, a colocated AP field, an unsolicited probe responses active field, a member of ESS with 2.4/5 GHz colocated AP field, an OCT supported with reporting AP field, a colocated with 6 GHz AP field, an extremely high throughput field, a sensing field, or a reserved field.

The access point reachability field may be used to indicate whether the reported AP may interact with the STA.

If the security field is set to 1, it may indicate that the AP (the reported AP) indicated by the BSSID supports a same security configuration as that used by a currently associated STA.

If this bit is set to 0, it may indicate that the AP does not support the same security configuration, or that the security information is currently unavailable.

If the key scope field is set to 1, it may indicate that the AP indicated by this BSSID has a same authenticator as the AP that transmits the report (referred to as a transmitting AP). If this bit is set to 0, it indicates that the AP has a different authenticator or related information is unavailable.

The capabilities field may include selected capabilities information of the AP indicated by this BSSID. A 1-bit subfield in this field has a same meaning and is set to a same value as a corresponding bit in the capabilities information field transmitted by the reported AP in a beacon. FIG. 3B is an example diagram of a format of a capabilities information field. As shown in FIG. 3B, the capabilities information field may include one or more of the following fields: a spectrum management field, a QoS field, an automatic power save delivery (APSD) field, a radio measurement field, or a reserved field.

The mobility domain field being set to 1 may indicate that the AP indicated by this BSSID includes a mobility domain element (MDE) in a beacon frame of the AP, and content of this MDE is the same as an MDE notified by the transmitting AP.

The high throughput field being set to 1 may indicate that the AP indicated by this BSSID is an HT AP, and an HT capabilities element (or an HT operation element) (if included as a subelement in the report) has the same content as an HT capabilities element (or an HT operation element) included in a beacon frame transmitted by the reported AP. Otherwise, this subfield is set to 0.

The very high throughput field being set to 1 may indicate that the AP indicated by this BSSID is a VHT AP, and a VHT capabilities element (or a VHT operation element) (if included as a subelement in the report) has the same content as a VHT capabilities element (or a VHT operation element) included in a beacon frame transmitted by the reported AP. Otherwise, this subfield is set to 0.

The FTM field being set to 1 may indicate that the AP indicated by this BSSID is an AP that has set the fine timing measurement responder field in the extended capabilities element to 1. The FTM field is set to 0, to indicate that the parameter dot11FineTimingMsmtRespActivated of the reported AP equals false, or the reported AP has not set the fine timing measurement responder field in the extended capabilities element to 1, or the fine timing measurement responder field of the reported AP is unavailable for the reported AP.

The high efficiency field being set to 1 may indicate that the AP indicated by this BSSID is an HE AP, and an HE capabilities element (or an HE operation element) (if included as a subelement in the report) has the same content as an HE capabilities element (or an HE operation element) included in a beacon frame transmitted by the reported AP. Otherwise, this field is set to 0.

The ER BSS field being set to 1 may indicate that an HE AP indicated by this BSSID transmits a beacon frame by using an HE ER SU PPDU. Otherwise, this field may be set to 0.

The colocated AP field being set to 1 indicates that the AP reported in this element is colocated with the AP that transmits this element.

The unsolicited probe responses active field may indicate: if the reported AP is part of an ESS in which all APs operate on a same channel as the reported AP, and are located on the same channel and within coverage of a STA that receives this frame, the parameter dot11UnsolicitedProbeResponseOptionActivated equals to true, and an unsolicited probe response frame is transmitted once every 20 time units (TU) or less. Otherwise, if the reported AP does not have this information, this field is set to 0.

The member of ESS with 2.4/5 GHz colocated AP field may indicate: if the reported AP is part of an ESS in which all APs operate in a same frequency band as the reported AP (regardless of an operating channel of the AP), a subfield of member of ESS with 2.4/5 GHz co-located APs is set to 1 and they are located on the same channel and within coverage of a STA that receives this frame, the parameter dot11MemberOfColocated6GHzESSOptionActivated equals to true, and there is also a corresponding AP operating in the 2.4 GHz or 5 GHz frequency band within the same co-located AP set. If the reported AP does not have the information, this field may be set to 0. If the reported AP operates in the 2.4 GHz or 5 GHz frequency band, this value is retained.

The OCT supported with reporting AP field being set to 1 may indicate support for the use of OCT to exchange MPDUs with the AP reported in the neighbor report element. Otherwise, this field may be set to 0.

The colocated with 6 GHz AP field being set to 1 may indicate that the AP reported in the neighbor report element is in a same colocated AP set as a 6 GHz AP, and the 6 GHZ AP may be discovered by the reported AP via a received management frame. Otherwise, this field is set to 0.

The extremely high throughput field being set to 1 may indicate that the AP indicated by this BSSID (the reported AP) is an EHT AP, and an EHT capabilities element (or an EHT operation element) (if included as a subelement in the report) has the same content as an EHT capabilities element (or an EHT operation element) included in a beacon frame transmitted by the reported AP. Otherwise, this field is set to 0.

The sensing field may be set to 1 if the AP identified by this BSSID is a sensing STA. If the AP identified by this BSSID is not a sensing STA or information about its support for WLAN sensing procedures is unavailable, the sensing field is set to 0.

### Reduced Neighbor Report Element

As mentioned above, a STA may discover the presence of an AP through scanning. To prevent the STA from continuously scanning channels and to reduce scanning time required by the STA, the AP may carry a reduced neighbor report element in a management frame. The reduced neighbor report element may be used to carry information about an AP (for example, a neighbor AP) near the AP, so that a STA that receives the management frame may establish an association with the neighbor AP based on the information about the neighbor AP.

It should be noted that in this application, the neighbor AP and the transmitting AP (the AP that transmits this element) may satisfy one of the following: the neighbor AP is an AP on another link within an AP MLD in which the transmitting AP is located; the neighbor AP is another AP detected in an operating area of the transmitting AP; the neighbor AP is an AP co-located with the transmitting AP; or, for example, the neighbor AP is another affiliated AP belonging to a same AP MLD as a current affiliated AP. Alternatively, the neighbor AP may satisfy another definition, which is not specifically limited in this application.

FIG. 4 is an example diagram of a format of the reduced neighbor report element. As shown in FIG. 4, the reduced neighbor report element may include the following fields: an element identifier (element ID) field, a length field, or one or more neighbor AP information fields.

The one or more neighbor AP information fields may be used to indicate target beacon transmission time (TBTT) and other information of a group of neighbor APs on a same channel.

One neighbor AP information field may include one or more of the following fields: a TBTT information header field, an operating class field, a channel number field, or a TBTT information set field.

The operating class field and the channel number field may together indicate a channel start frequency of a primary channel of a BSS of an AP in the neighbor AP information field.

The channel number field may indicate the last known primary channel of the AP in the neighbor AP information field.

The TBTT information header field may include one or more of the following fields: a TBTT information field type field, a filtered neighbor AP field, a reserved field, a TBTT information count field, or a TBTT information length field.

The TBTT information field type field and the TBTT information length field together indicate a format of the TBTT information header field. A value of the TBTT information field type field may be 0. Values 1, 2, and 3 may be reserved.

The filtered neighbor AP field has a meaning only when the RNR element is in a probe response frame transmitted by a VHT AP. Otherwise, this field is reserved.

The TBTT information count field may be used to indicate a quantity of TBTT information fields included in a TBTT information set field minus one.

The TBTT information length field may be used to indicate a length of each TBTT information field.

A TBTT information set includes one or more TBTT information fields. The TBTT information field may include one or more of the following fields: a neighbor AP TBTT offset field, a BSSID field (optional), a short service set identifier (short SSID) field, a BSS parameter field, or a 20 MHz power spectral density (PSD) field.

The neighbor AP TBTT offset field may indicate a time offset in a unit of TUs. If the reported AP is not part of a multiple BSSID set or does not correspond to a transmitted BSSID of a multiple BSSID set, a next TBTT of the reported AP starts from a previous TBTT of the AP that transmits this element. If the reported AP is part of a multiple BSSID set and corresponds to a non-transmitted BSSID, a next TBTT of a transmitted BSSID of the multiple BSSID set of the reported AP starts from a previous TBTT of the AP that transmits this element.

The BSSID field may be used to indicate a BSSID of an AP.

The short SSID field may be used to indicate a short SSID.

The BSS parameter field may be used to indicate some parameters of a BSS identified by this BSSID. The BSS parameter field may include one or more of the following fields: an on-channel tunneling recommended (OCT recommended) field, a same SSID field, a multiple BSSID field, a transmitted BSSID field, a member of ESS with 2.4/5 GHz co-located AP field, an unsolicited probe response active field, a co-located AP field, or a reserved field.

The on-channel tunneling recommended field being set to 1 may indicate that it is suggested to use OCT to exchange, through wireless transmission, MMPDUs with the AP identified in the TBTT information field and that the AP transmits a reduced neighbor report element. Otherwise, this field may be set to 0.

The same SSID field being set to 1 may indicate that the transmitting AP and the reported AP have a same SSID. Otherwise, this field may be set to 0.

The multiple BSSID field being set to 1 may indicate that the reported AP belongs to a multiple BSSID set. Otherwise, this field may be set to 0.

The transmitted BSSID field being set to 1 may indicate that the reported AP corresponds to a transmitted BSSID. If the reported AP corresponds to a non-transmitted BSSID, this field is set to 0. If the multiple BSSID field is set to 0, this field is reserved.

The member of ESS with 2.4/5 GHz co-located AP field may be used to indicate: if the reported AP is part of an ESS in which all APs operate in a same frequency band as the reported AP (regardless of an operating channel of the AP), and are located on a same channel as and within coverage of a STA that receives this frame, dot11MemberOfColocated6GHzESSOptionActivated equals to true, and there is also a corresponding AP operating in the 2.4 GHz or 5 GHz frequency band within a same co-located AP set as this AP, this field is set to 1. Otherwise, if the reported AP does not have this information, this field is set to 0. If the reported AP operates in the 2.4 GHz or 5 GHz frequency band, this value is retained.

The unsolicited probe response active field being set to 1 may indicate: if the reported AP is part of an ESS in which all APs operate on a same channel as the reported AP, and are located on the same channel as and within coverage of a STA that receives this frame, dot11UnsolicitedProbeResponseOptionActivated equals to true, and an unsolicited probe response frame is transmitted once every 20 TUs or less. Otherwise, if the reported AP does not have this information, this field is set to 0.

The colocated AP field may be set to 1 if the AP is in a same colocated AP set as the transmitting AP. Otherwise, this field may be set to 0.

If the 20 MHz PSD field is present, it indicates maximum transmit power for a default category. The unit of PSD EIRP may be interpreted as dBm/MHz, corresponding to the reported 20 MHz primary channel. The maximum transmit power is encoded as a two's complement signed integer. The value −128 is reserved. The value +127 indicates that no maximum transmit power is specified for the corresponding 20 MHz channel. For all other values Y (that is, −127 to +126) of the subfield, maximum transmit power in the 20 MHz channel is Y/2 dBm/MHz (that is, ranging from −63.5 dBm/MHz to +63 dBm/MHz).

With the development of technologies, communications devices may support an increasing quantity of communication technologies. In other words, capabilities information of communications devices is becoming more diverse. However, techniques for indicating capabilities information cannot keep pace with technological development, causing it difficult to well apply some communication technologies in practical communication scenarios.

FIG. 5 is a schematic flowchart of a wireless communication method according to an embodiment of this application, to resolve the foregoing problems. The method illustrated in FIG. 5 may be executed by a first device and a second device. Both the first device and the second device may be the communications devices described above. For example, the first device may be an AP or a non-AP STA. For another example, the second device may be an AP or a non-AP STA.

The method illustrated in FIG. 5 may include step S510.

In step S510, the first device transmits first indication information to the second device.

The first indication information may be used to indicate capabilities information of a target device. The target device is described below.

Optionally, the target device may include the first device. In other words, the first indication information may be used to indicate capabilities information of the first device.

Optionally, the target device may include a third device. The third device may be a device different from both the first device and the second device. For example, the third device may be another device near the first device. In other words, the third device may be a device neighbor to the first device. For example, the first device may include an AP, and the third device may include one or more neighbor APs of the AP.

It should be noted that the target device may include one or more devices. The target device may include an AP and/or a non-AP STA. For a case in which the target device includes an AP, this AP may be referred to as a target AP. For a case in which the target device includes a non-AP STA, the non-AP STA may be referred to as a target non-AP STA.

It may be understood that a capability may refer to a support status of the target device for one or more technologies. The support status may include, for example: whether one or more technologies are supported; for one or more technologies, parameters that can be supported (including a maximum parameter and/or a minimum parameter, and the like), and the like.

This application proposes that the capabilities information of the target device that is indicated by the first indication information may include one or more of the following information of the target device: a multi-AP coordination capability; a secondary channel access capability; a capability of priority channel access; a support status of a link adaptation function; a support status of a relay function; a capability of transmission based on a DRU; a mobility capability; a power supply mode; a capability related to preemption; a capability to support a target protocol; a capability of enhanced roaming; a support status of a TXOP sharing function based on a non-triggered frame; a power-saving capability; a support status of an A-MPDU length passive adjustment function; a support status of a 320 MHz frequency aggregation PPDU; a support status of an RU adaptation function; a support status of a replication function; a capability of inserted PPDU-based communication; or a capability of communication in a frequency band above 45 GHZ, which are separately described below.

The multi-AP coordination technology may also be referred to as a multi-AP cooperation technology. The multi-AP coordination may allow a plurality of APs to share transmission resources, thereby improving utilization of transmission resources. An AP may initiate or participate in a multi-AP coordinated transmission process. Modes of multi-AP coordination may include: coordinated uplink multi user multiple input multiple output (UL MU-MIMO) transmission, coordinated beamforming (C-BF), coordinated spatial reuse (C-SR), multi-AP joint transmission, coordinated time division multiple access (C-TDMA), coordinated orthogonal frequency division multiple access (C-OFDMA) transmission, and the like. Based on this, the capability of multi-AP coordination may include one or more of the following: whether the multi-AP coordination function is supported, whether a multi-AP coordinated transmission processes can be initiated, whether a multi-AP coordinated transmission process can be responded to, a supported or unsupported mode of multi-AP coordination, or the like.

Channels may be classified into a primary channel and a secondary channel (or referred to as a non-primary channel, an auxiliary channel, a supplementary channel, or a sub-channel). In a case in which the target device can access a secondary channel, the communications device may determine, based on a channel state of the primary channel, whether to access the secondary channel. For example, when the channel state of the primary channel is idle, the device can perform communication on the primary channel. For another example, when the channel state of the primary channel is busy, the device may switch to the secondary channel for communication. Based on this, the device may have the capability of secondary channel access. The capability of secondary channel access will be described in detail later and is not repeated here.

Based on some communication technologies, a communications device can preferentially access a channel. For example, the device may implement priority access based on enhanced distributed channel access (EDCA). Based on this, the capability of priority channel access may include: whether the EDCA-based priority access function can be supported.

Some communications devices may support the link adaptation function. For a device that supports the link adaptation function, the device may set corresponding link parameters according to a link status. The link adaptation function may be specific to a specific communication technology. For example, the link adaptation function may refer to a link adaptation function that can be supported by a UHR technology. In other words, the link adaptation function may include a UHR link adaptation function. The support status of the link adaptation function may include: whether the link adaptation function is supported.

In a communication process based on the relay function, communication between devices may be implemented via relay stations. For example, a STA 1 may communicate with a STA 2 via a relay station. In other words, a relay STA may forward a signal that is transmitted by the STA 1 and whose destination is the STA 2 to the STA 2. Based on this, the support status of the relay function may include: whether serving as a relay station is supported.

A DRU may have discontinuous subcarriers. Similarly, multiple resource units (MRU) may correspond to distributed multiple resource units (DMRU). A communications device may support DRUs of different bandwidths, that is, it may support transmission and/or reception of PPDUs of DRUs of a corresponding bandwidth. For example, the communications device may support DRUs of one or more of the following bandwidths: less than or equal to 80 MHz, 160 MHz, or 320 MHz. Based on this, the capability of transmission based on a DRU may include: whether DRU-based transmission is supported, a bandwidth of a supported DRU, whether a DRU having a bandwidth less than or equal to 80 MHz is supported, whether a DRU having a bandwidth of 160 MHz is supported, whether a DRU having a bandwidth of 320 MHz is supported, and whether an enhanced distributed resource unit (EDRU) is supported.

The mobility capability may refer to a capability of a communications device to move while implementing communication during movement. For this, the mobility capability may include: whether the device is mobile. It should be noted that in related technologies, considering factors such as power supply, APs are mostly fixed. With technological advancements, APs may be mobile APs. Therefore, for a case in which the target device includes a target AP, the mobility capability may also include whether the target AP is mobile.

Power supply modes of devices may differ. For example, a device may be powered by a battery. For another example, a device may be powered by a non-battery source (for example, an external power supply). In this regard, the power supply mode may include: whether the device is powered solely by a battery. For a case in which the target device includes an AP, in related technologies, due to that APs consume a relatively large amount of power and are not required to be mobile, APs mostly require non-battery power supply. In a UHR technology, an AP may be powered solely by a battery. Based on this, the power supply mode may include: whether the target AP is powered solely by a battery.

Some devices may initiate TXOP preemption (referred to as preemption) to seize a TXOP held by another device. A device that can initiate preemption may be referred to as an initiator in preemption. A holder of the TXOP may respond to the preemption to indicate whether the preemption is successful. A device that can respond to preemption may be referred to as a responder in preemption. In a case in which the preemption is successful, the initiator may perform active signal transmission by using the TXOP acquired by preemption. Based on this, capabilities related to preemption may include: whether the device supports being an initiator in preemption, or whether the device supports being a responder in preemption.

The target protocol may include a UHR protocol or other protocols. Based on this, the capability to support the target protocol may include: whether the UHR protocol is supported.

The capability of enhanced roaming may include: whether the enhanced roaming function is supported.

Some communications devices may implement TXOP sharing based on a non-triggered frame. For example, a communications device may implement TXOP sharing through specific control frames. For example, if a UHR AP supports implementation of TXOP sharing based on a non-triggered frame, the UHR AP may respond to a specific control frame, thereby obtaining a TXOP shared by a UHR non-AP STA with the UHR AP. For another example, if a UHR non-AP STA supports implementation of TXOP sharing based on a non-triggered frame, the UHR non-AP STA may transmit a specific control frame to share the TXOP with the UHR AP. Based on this, the support status of the TXOP sharing function based on the non-triggered frame may include one or more of the following: whether implementation of TXOP sharing based on the non-triggered frame is supported, whether the target AP can receive a non-triggered frame to obtain a TXOP shared by a non-AP STA, or whether the target non-AP STA can transmit a non-triggered frame to share a TXOP with an AP.

Some APs (for example, UHR APs) may support one or more operation modes, enabling the APs to have higher energy efficiency compared to other types of APs (EHT/HE/VHT/HT AP), that is, these APs support an AP power save function. The power save capability may include: whether the AP power save function is supported.

Some communications devices may passively adjust, based on signalling transmitted by other devices, a length of an A-MPDU transmitted by them. This function may be referred to as an A-MPDU length passive adjustment function. The support status of the A-MPDU length passive adjustment function may include: whether the A-MPDU length passive adjustment function is supported.

Some communications devices may transmit and/or receive frequency aggregation PPDUs having a bandwidth of 320 MHz. The support status of the 320 MHz frequency aggregation PPDU may include: whether transmission and/or reception of a frequency aggregation PPDU having a bandwidth of 320 MHz is supported.

Some communications devices may autonomously puncture one or more RUs when transmitting trigger-based (TB) PPDUs to avoid interference from interfering signals. This function may be referred to as an RU adaptation function. Based on this, the support status for the RU adaptation function may include: whether the RU adaptation function is supported.

The replication function may refer to that a station transmits same data within one PPDU by using different transmission resources. The transmission resources may include one or more of the following: a frequency-domain resource, a time-domain resource, or a spatial-domain resource. For example, same data may be transmitted within one PPDU by using different RUs and/or OFDM symbols. In other words, a device that supports the replication function may receive and/or transmit PPDUs satisfying one or more of the following: frequency-domain replication, time-domain replication, or spatial-domain replication. It may be understood that the replication function may improve transmission reliability. Bandwidths supported for replication may vary among different devices. For example, a bandwidth for replication of PPDUs that can be supported by a communications device may be: less than or equal to 80 MHz, equal to 160 MHz, or equal to 320 MHz. The support status of the replication function may include one or more of the following: whether the replication function is supported, a bandwidth supported for replication, whether replication with a bandwidth less than or equal to 80 MHz is supported, whether replication with a bandwidth equal to 160 MHz is supported, or whether replication with a bandwidth equal to 320 MHz is supported.

If a PPDU transmitted between communications devices is an inserted PPDU, during an exchange process, the PPDU may be interrupted to transmit another PPDU (for example, a PPDU carrying data that is more urgent). Based on this, the capability of inserted PPDU-based communication may include: whether reception of an inserted PPDU is supported, and whether transmission of an inserted PPDU is supported.

If a communications device has an affiliated link in a frequency band above 45 GHZ, the communications device may support transmission and reception in a frequency band above 45 GHz. Based on this, the capability of communication in a frequency band above 45 GHz may include: whether reception and/or transmission in a frequency band above 45 GHz is supported, and whether there is an affiliated link in a frequency band above 45 GHz.

In some embodiments, the capabilities information indicated by the first indication information may be related to the UHR technology, and/or the first indication information indicates capabilities information of a UHR station. Therefore, the capabilities information indicated by the first indication information may also be referred to as UHR capabilities information.

Optionally, the capabilities information indicated by the first indication information may also include other capabilities related to the UHR technology and/or capabilities possessed by a UHR station.

Through the first indication information, communications devices (for example, UHR devices) can effectively discover and learn related capabilities of other communications devices, thereby achieving more efficient and accurate communication. For example, based on the capabilities information of the target AP that is indicated by the first indication information, a non-AP STA can more quickly and accurately select a suitable AP for association.

It should be noted that the first indication information may be included in one or more elements. The first indication information may be included in one or more frames. The first indication information may be included in one or more fields.

It should be noted that if one or more fields including the first indication information indicate capabilities that only APs can have, for the case in which the target device is a non-AP STA, values of the one or more fields may be reserved. Similarly, if one or more fields including the first indication information indicate capabilities that only non-AP STAs can have, for the case in which the target device is an AP, values of the one or more fields may be reserved.

The capability of secondary channel access is described in detail below.

In some embodiments, the capability of secondary channel access may include one or more of the following capabilities of the target device: whether a secondary channel access function is supported; a physical layer version of a supported secondary channel access function; a quantity of secondary channels supported for access; information about a first secondary channel supported for access; power-saving information for performing secondary channel access; a channel switch delay; a secondary channel suggested for use; a capability to transmit and/or receive a PPDU on a secondary channel; whether it is possible to broadcast a beacon frame on a secondary channel; whether it is possible to receive a probe request frame on a secondary channel; or whether it is possible to reply with a probe response frame on a secondary channel.

The physical layer version of the supported secondary channel access function may include, for example, one or more of the following: HT PHY, VHT PHY, HE PHY, EHT PHY, or UHR PHY.

Optionally, the physical layer version of the supported secondary channel access function may be represented by a bitmap. One or more bits in the bitmap may be in a one-to-one correspondence with one or more physical layer versions. For example, the bitmap may include eight bits. B0 may indicate HT PHY; B1 may indicate VHT PHY; B2 may indicate HE PHY; B3 may indicate EHT PHY; B4 may indicate UHR PHY; and B5-B7 may be reserved.

For example, a value of a first bit in the bitmap being 1 may indicate that the target device supports the secondary channel access function of a corresponding PHY version; and the value of the first bit being 0 may indicate that the target device does not support the secondary channel access function of a corresponding PHY version. For example, a bitmap of 10101000 may indicate support for HT PHY, HE PHY, and UHR PHY; and no support for VHT PHY and EHT PHY.

For example, a value of a first bit in the bitmap being 0 may indicate that the target device supports the secondary channel access function of a corresponding PHY version; and the value of the first bit being 1 may indicate that the target device does not support the secondary channel access function of a corresponding PHY version. For example, a bitmap of 10101000 may indicate no support for HT PHY, HE PHY, and UHR PHY; and support for VHT PHY and EHT PHY.

A secondary channel suggested for use is a secondary channel suggested to be preferentially used when the primary channel is busy. If a plurality of secondary channels are suggested for use, the first one, the last one, or any one of the secondary channels suggested for use may be preferentially used.

Power saving may include that a communications device may reduce energy consumption in an active state through intermittent sleep. The power-saving information for performing secondary channel access may indicate one or more of the following: whether the target device performs power saving on a secondary channel; a power save mode used by the target device on a secondary channel; a time window during which the target device is in an active state in the power save mode. The power save mode may include periodic sleep, random sleep, and the like. The time window may be a period of time. The time window may be represented by one or more of the following: a start instant, duration, an end instant, or periodicity.

If the target device can support one or more of the following: broadcasting a beacon frame on a secondary channel, receiving a probe frame on a secondary channel, replying with a probe response frame on a secondary channel, another device can detect the target device on the secondary channel through scanning. In a case in which the first indication information indicates the secondary channel access capability, another non-AP STA may perform a scan for the target device on a secondary channel, thereby detecting the target device more quickly through scanning.

The channel switch delay may refer to time required for the target device to switch an operating channel. The unit of the channel switch delay is not limited in this application. For example, the unit may be microseconds or milliseconds.

The capability of secondary channel access may include a capability of accessing one or more secondary channels. The one or more secondary channels may be secondary channels supported for access, that is, the quantity of one or more secondary channels may be the quantity of secondary channels supported for access. The one or more secondary channels may include the first secondary channel. In other words, the information about the first secondary channel may include a status of a secondary channel that the target device supports for access. For example, the first indication information may indicate a status of each secondary channel that the target device supports for access.

The information about the first secondary channel may include one or more of the following information about the first secondary channel: an identifier; a bandwidth; second indication information; a center frequency; information about a punctured channel included.

The identifier may be used to distinguish between different secondary channels. In other words, the first secondary channel may have a unique identifier to distinguish it from other channels.

A bandwidth of the first secondary channel may be 20 MHz, 40 MHz, 80 MHz, 160 MHz, 320 MHz, or the like. The bandwidth of the first secondary channel may be indicated by an index. For example, a value of the index being 0 may indicate a bandwidth of 20 MHz; a value of 1 may indicate a bandwidth of 40 MHz; a value of 2 may indicate a bandwidth of 80 MHz; a value of 3 may indicate a bandwidth of 160 MHz; a value of 4 may indicate a bandwidth of 320 MHz; and values 5-7 may be reserved.

Similarly, a center frequency of the first secondary channel may be indicated by an index.

The second indication information may be used to indicate whether it is suggested to preferentially use the first secondary channel.

The first secondary channel may include a punctured channel (or referred to as a subchannel). For example, channels within the first secondary channel may be punctured at a granularity of 20 MHz. In other words, the bandwidth of the first secondary channel may be divided into one or more 20 MHz subchannels. The information about the first secondary channel may indicate a puncturing status of each of the one or more 20 MHz subchannels. For example, information about a punctured channel included within the first secondary channel may be identified by the bitmap. One or more bits in the bitmap may be in a one-to-one correspondence with one or more subchannels included within the first secondary channel. For example, the bitmap may be 16 bits. The lowest-numbered bit in the bitmap may correspond to a 20 MHz subchannel with the lowest frequency within the bandwidth of the first secondary channel. For subsequent bits, each successive bit may correspond to a next higher-frequency 20 MHz subchannel. Bits in the bitmap that exceed the bandwidth of the first secondary channel may be reserved. A first bit in the bitmap being set to 1 may indicate that the corresponding 20 MHz subchannel is punctured, and being set to 0 may indicate that the corresponding 20 MHz subchannel is not punctured. Alternatively, the first bit in the bitmap being set to 0 may indicate that the corresponding 20 MHz subchannel is punctured, and being set to 1 may indicate that the corresponding 20 MHz subchannel is not punctured.

In some embodiments, the capability of secondary channel access may be included in a secondary channel operation element.

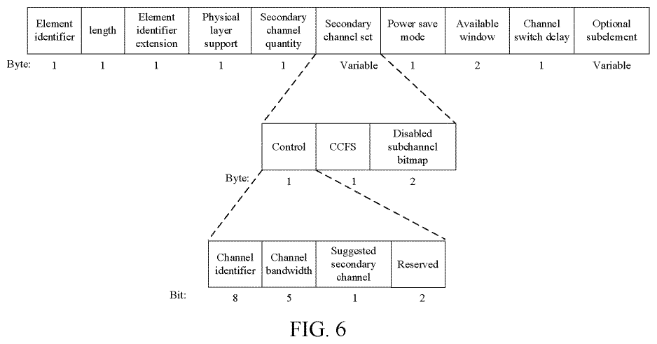

FIG. 6 is a schematic diagram of a format of a secondary channel operation element according to an embodiment of this application.

As shown in FIG. 6, the secondary channel operation element may include one or more of the following fields: an element identifier field, a length field, an element identifier extension field, a physical layer support (PHY support) field, a secondary channel quantity (number of secondary channels) field, a secondary channel set field, a power save mode field, an available window field, a channel switch delay field, or an optional subelement field, which are separately described below.

The element identifier may be used to indicate an identifier of the secondary channel operation element. A value of the element identifier may be 255, indicating that this element is an extended element, and a type this element is required to be determined in combination with the element identifier extension field.

The length field is used to indicate a quantity of bytes in the element other than the element identifier and the length field.

The element identifier extension field is used to indicate an element extension identifier. A value of the element identifier extension field may be any integer between 135 and 255, so that this field and the element identifier field jointly indicate that this element is a secondary channel operation element. The element identifier extension field may be, for example, 158.

The physical layer support field may be used to indicate a physical layer version of the secondary channel access function supported by the target device. The physical layer support field may be in the form of a bitmap. In the bitmap, a value of each bit being 1 indicates support for the corresponding PHY version, and a value of 0 may indicate no support for the corresponding PHY version. In an embodiment, B0 may indicate HT PHY, B1 may indicate VHT PHY, B2 may indicate HE PHY, B3 may indicate EHT PHY, B4 may indicate UHR PHY, and B5-B7 are reserved.

The secondary channel quantity field may indicate a quantity of secondary channels that the target device supports for access. In other words, the secondary channel quantity field may indicate a quantity of secondary channels included in this element, that is, a quantity of secondary channels indicated in the secondary channel set field.

The secondary channel set field may indicate specific information about one or more secondary channels. The one or more secondary channels may be the secondary channels that the target device supports for access. The secondary channel set field may include information fields of one or more secondary channels. A quantity of information fields of secondary channels that are included in the secondary channel set field may be the same as that indicated in the secondary channel quantity field. An information field of a secondary channel may include one or more of the following fields: a control field, a channel center frequency (represented as CCFS in FIG. 6) field, or a disabled subchannel bitmap field.

The control field may include one or more of the following fields: a channel identifier (channel ID) field, a channel bandwidth field, a suggested secondary channels field, or a reserved field.

The channel identifier field may indicate an identifier of a secondary channel, for example, may indicate a unique identifier of a secondary channel. All that is indicated in the information field of the secondary channel is information about the secondary channel identified by this channel identifier field.

The channel bandwidth field may indicate a bandwidth of a corresponding secondary channel. For example, a correspondence between a value of the channel bandwidth field and a bandwidth may be: a value of 0 indicates 20 MHz; a value of 1 indicates 40 MHz; a value of 2 indicates 80 MHz; a value of 3 indicates 160 MHz; a value of 4 indicates 320 MHz; and values 5-7 are reserved.

The suggested secondary channels field may indicate whether it is suggested to preferentially use this secondary channel. For example, a value of the suggested secondary channels field being 1 may indicate yes (that is, suggested for priority use), and a value of the suggested secondary channels field being 0 may indicate no (that is, not suggested for priority use). For another example, a value of the suggested secondary channels field being 0 may indicate yes, and a value of the suggested secondary channels field being 1 may indicate no.

The CCFS field may indicate an index of a center frequency of this secondary channel.

The disabled subchannel bitmap field may indicate information about a punctured channel within this secondary channel. The disabled subchannel bitmap may be a 16-bit bitmap. The lowest-numbered bit may correspond to a 20 MHz subchannel with the lowest frequency within the bandwidth of the secondary channel. Each successive bit in the bitmap corresponds to a next higher-frequency 20 MHz subchannel. A bit in the bitmap within the bandwidth of the secondary channel being set to 1 may indicate that the corresponding 20 MHz subchannel is punctured, and the bit being set to 0 may indicate that the corresponding 20 MHz subchannel is not punctured. Bits in the bitmap that exceed the bandwidth of the secondary channel may be reserved.

The power save mode field may indicate whether the target device uses a power save mode on the secondary channel, or a type of a power save mode to be used. A value of 0 indicates that no power save mode is used, a value of 1 indicates a power save mode 1 (for example, periodic sleep), a value of 2 indicates a power save mode 2 (for example, random sleep), and other values are reserved.

When the power save mode field indicates that the target device is in a power save mode, the available window field may indicate a time window during which the target device is in the active state in the power save mode.

The channel switch delay field may indicate time required for the target device to switch an operating channel. The unit may be microseconds or milliseconds.

The optional capabilities element field may be used to indicate capabilities the target device possesses when transmitting or receiving PPDUs on a secondary channel. Through this field, capabilities the target device possesses when receiving PPDUs on the secondary channel and the primary channel may be indicated separately, thereby enabling accurate capability indication even when there are differences between the capabilities of the target device on the secondary channel and those on the primary channel.

For example, the optional capabilities element field may include one or more related elements that describe in detail the capabilities of the target device on the secondary channel. Each element in Table 1 indicates a capability that a station possesses when transmitting or receiving PPDUs on a secondary channel, and the capability may differ from a capability that the station possesses when transmitting or receiving PPDUs on the primary channel.

Elements related to capabilities may include one or more of the following: an HT capabilities element, a VHT capabilities element, an HE capabilities element, an EHT capabilities element, a UHR capabilities element, a basic multi-link. Definitions or formats of these capabilities elements may be as described in this application or related technologies.

A correspondence between a subelement identifier (subelement ID) and a capability-related element may be as shown in Table 1.

TABLE 1

| Subelement | | |
|---|---|---|
| identifier | Name | Extensible |
| 0 | Reserved | — |
| 45 | HT capabilities | Yes |
| 191 | VHT capabilities | Yes |
| 193 | HE capabilities | Yes |
| 199 | EHT capabilities | Yes |
| 201 | Basic multi-link | Yes |
| 202 | UHR capabilities | Yes |
| 203-220 | Reserved | — |

It should be noted that part of content in Table 1 may be implemented independently. In other words, content in Table 1 may be implemented after deleting part of the content. In addition, content may be added to Table 1. This is not limited in this application.

The secondary channel operation element may be included in one or more of the following frames: a beacon frame, an association request frame, an association response frame, a reassociation request frame, a reassociation response frame, a probe request frame, or a probe response frame. It may be understood that the frames involved in the capability discovery related processes described above may each include the secondary channel operation element. In other words, the discovery process of the capability of secondary channel access may be implemented through the foregoing capability discovery processes.

As mentioned above, the target device may include a first device, that is, the first indication information may indicate its own capabilities information. In this case, part or all of the information in the first indication information may be included in a first capabilities element. As described above, the capabilities information indicated by the first indication information may be related to the UHR technology. Therefore, in some embodiments, the first capabilities element may also be referred to as a UHR capabilities element, that is, an element used to indicate UHR-related capabilities.

The first capabilities element may be used to indicate whether the first device supports one or more of the following: a multi-AP coordination function; a secondary channel access function; an initiator in a preemption function; a responder in a preemption function; a priority channel access function; a link adaptation function; a relay function; an enhanced roaming function; a TXOP sharing function based on a non-triggered frame; an AP power save function; an A-MPDU length passive adjustment function; a 320 MHz frequency aggregation PPDU; a distributed RU; an enhanced distributed RU; an RU adaptation function; a replication function; a receiver in an inserted PPDU function; a transmitter in an inserted PPDU function; or transmission and reception in a frequency band above 45 GHz. Descriptions of the foregoing information are detailed earlier and will not be repeated here.

Optionally, the capabilities information indicated by the first capabilities element may include MAC capabilities information and/or PHY capabilities information. The MAC capabilities information may be related to MAC capabilities of the first device. For example, the MAC capabilities information may be used to indicate whether the first device supports one or more of the following: a multi-AP coordination function; a secondary channel access function; an initiator in a preemption function; a responder in a preemption function; a priority channel access function; a link adaptation function; a relay function; an enhanced roaming function; a TXOP sharing function based on a non-triggered frame; an AP power save function; an A-MPDU length passive adjustment function; or a 320 MHz frequency aggregation PPDU. The PHY capabilities information may be related to PHY capabilities of the first device. For example, the PHY capabilities information may be used to indicate whether the first device supports one or more of the following: a distributed RU; an enhanced distributed RU; an RU adaptation function; a replication function; a receiver in an inserted PPDU function; a transmitter in an inserted PPDU function; or transmission and reception in a frequency band above 45 GHz.

It should be noted that in a case in which the first capabilities element indicates the secondary channel access function, the first capabilities element may include the secondary channel operation element described above.

The first capabilities element may further indicate other capabilities information. For example, the first capabilities element may further indicate one or more of the following information about the first device: a combination of UHR-MCS and quantity of spatial streams (NSS) supported for reception and transmission; or nominal physical layer packet extension (PPE) values for specific RU, MRU, DRU, and EDRU allocation and specific NSS in a UHR PPDU.

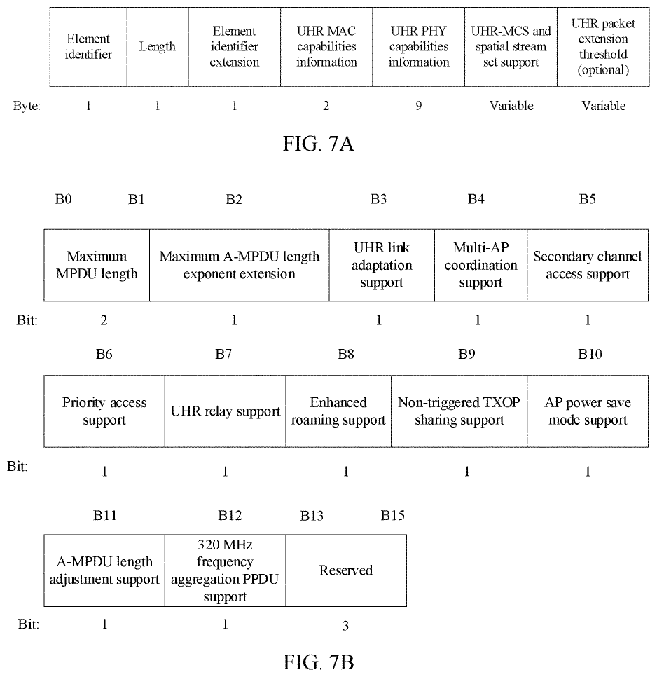

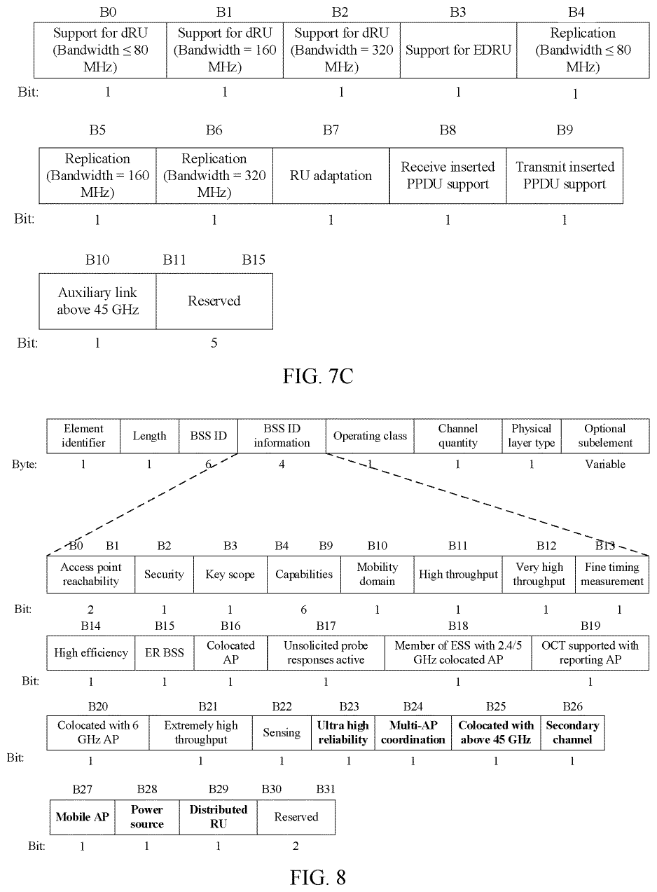

FIG. 7A is an example diagram of a format of the first capabilities element according to an embodiment of this application.

As shown in FIG. 7A, the first capabilities element may include one or more of the following fields: an element identifier field, a length field, an element identifier extension field, a UHR MAC capabilities information field, a UHR PHY capabilities information field, a supported UHR-MCS and NSS set field, or a UHR PPE thresholds field.

The element identifier field may be used to indicate an identifier of the first capabilities element. A value of the element identifier field may be 255, indicating that this element is an extension element. In other words, this element is required to be indicated by the element identifier field together with the element identifier extension field.

The length field may be used to indicate a quantity of bytes in the first capabilities element other than the element identifier field and the length field.

The element identifier extension field may be used to indicate an element extension identifier. The element identifier extension field may be combined with the element identifier field, to indicate that this element is the first capabilities element. A value of the element identifier extension field may be any integer between 135 and 255. For example, a value of the element identifier extension field may be 155.

The UHR MAC capabilities information field may indicate MAC capabilities information of the first device.

The UHR PHY capabilities information field may indicate PHY capabilities information of the first device.

The supported UHR-MCS and NSS set field may indicate a combination of UHR-MCS and a quantity of spatial streams that the first device supports for reception and transmission.

The UHR PPE thresholds field may indicate nominal packet extension values for specific RU, MRU, DRU, and EDRU allocation and specific NSS in UHR PPDUs.

Formats of the UHR MAC capabilities information field and the UHR PHY capabilities information field are described in detail below with reference to FIG. 7B and FIG. 7C.

FIG. 7B is a schematic diagram of a format of the UHR MAC capabilities information field.

As shown in FIG. 7B, the UHR MAC capabilities information field may include one or more of the following fields: a maximum MPDU length field, a maximum A-MPDU length exponent extension field, a UHR link adaptation support field, a multi-AP coordination support field, a secondary channel access support field, a priority access support field, a UHR relay support field, an enhanced roaming support field, a non-triggered TXOP sharing support field, an AP power save mode support field, an A-MPDU length adaptation support field, or a 320 MHz frequency aggregation PPDU support (frequency aggregation PPDU (BW=320 MHz)) field.

The UHR link adaptation support field may be used to indicate whether the first device supports the UHR link adaptation function. In some embodiments, a value of the UHR link adaptation support field being 1 may indicate that the first device can support UHR link adaptation. The value of the UHR link adaptation support field being 0 may indicate that the first device cannot support UHR link adaptation. In some embodiments, a value of the UHR link adaptation support field being 0 may indicate that the first device can support UHR link adaptation. The value of the UHR link adaptation support field being 1 may indicate that the first device cannot support UHR link adaptation.

The multi-AP coordination support field may be used to indicate whether the first device supports the multi-AP coordination function. In some embodiments, when the first device is a UHR AP station, a value of the multi-AP coordination support field being 1 may indicate that the UHR AP can support the multi-AP coordination function. The value of the multi-AP coordination support field being 0 may indicate that the UHR AP cannot support the multi-AP coordination function. In some embodiments, when the first device is a UHR AP station, a value of the multi-AP coordination support field being 0 may indicate that the UHR AP can support the multi-AP coordination function. The value of the multi-AP coordination support field being 1 may indicate that the UHR AP cannot support the multi-AP coordination function. When the first device is a UHR non-AP STA, the multi-AP coordination support field may be reserved.

The secondary channel access support field may be used to indicate whether the first device supports the secondary channel access function. In some embodiments, a value of the secondary channel access support field being 1 may indicate that the first device can support the secondary channel access function. The value of the secondary channel access support field being 0 may indicate that the first device cannot support the secondary channel access function. In some embodiments, a value of the secondary channel access support field being 0 may indicate that the first device can support the secondary channel access function. The value of the secondary channel access support field being 1 may indicate that the first device cannot support the secondary channel access function.

The priority access support field may be used to indicate whether the first device supports the priority channel access function. In some embodiments, a value of the priority access support field being 1 may indicate that the first device can support the EDCA-based priority access function. The value of the priority access support field being 0 may indicate that the first device cannot support the EDCA-based priority access function. In some embodiments, a value of the priority access support field being 0 may indicate that the first device can support the EDCA-based priority access function. The value of the priority access support field being 1 may indicate that the first device cannot support the EDCA-based priority access function.

The UHR relay support field may be used to indicate whether the first device supports the relay function. In some embodiments, a value of the UHR relay support field being 1 may indicate that the first device can serve as a relay station. A value of the UHR relay support field being 0 may indicate that the first device cannot serve as a relay station. In some embodiments, a value of the UHR relay support field being 0 may indicate that the first device can serve as a relay station. A value of the UHR relay support field being 1 may indicate that the first device cannot serve as a relay station.

The enhanced roaming support field may be used to indicate whether the first device supports the enhanced roaming function. In some embodiments, a value of the enhanced roaming support field being 1 may indicate that the first device can support the enhanced roaming function. The value of the enhanced roaming support field being 0 may indicate that the first device cannot support the enhanced roaming function. In some embodiments, a value of the enhanced roaming support field being 0 may indicate that the first device can support the enhanced roaming function. The value of the enhanced roaming support field being 1 may indicate that the first device cannot support the enhanced roaming function.

The non-triggered TXOP sharing support field may be used to indicate whether the first device supports the TXOP sharing function based on the non-triggered frame.

In some embodiments, when the first device is a UHR AP, a value of the non-triggered TXOP sharing support field being 1 may indicate that the UHR AP can respond to specific control frames, thereby obtaining TXOP time shared by a UHR non-AP STA with the UHR AP; and the value of the non-triggered TXOP sharing support field being 0 may indicate that the UHR AP cannot respond to specific control frames, that is, cannot obtain TXOP time shared by a UHR non-AP STA with the UHR AP. When the first device is a UHR AP, a value of the non-triggered TXOP sharing support field being 0 may indicate that the UHR AP can respond to specific control frames, thereby obtaining TXOP time shared by a UHR non-AP STA with the UHR AP; and the value of the non-triggered TXOP sharing support field being 1 may indicate that the UHR AP cannot respond to specific control frames, that is, cannot obtain TXOP time shared by a UHR non-AP STA with the UHR AP.

In some embodiments, when the first device is a UHR non-AP STA, a value of the non-triggered TXOP sharing support field being 1 may indicate that the UHR non-AP STA can transmit specific control frames, thereby sharing TXOP time with a UHR AP; and the value of the non-triggered TXOP sharing support field being 0 may indicate that the UHR non-AP STA cannot transmit specific control frames, that is, cannot share TXOP time with the UHR AP. When the first device is a UHR non-AP STA, a value of the non-triggered TXOP sharing support field being 0 may indicate that the UHR non-AP STA can transmit specific control frames, thereby sharing TXOP time with a UHR AP; and the value of the non-triggered TXOP sharing support field being 1 may indicate that the UHR non-AP STA cannot transmit specific control frames, that is, cannot share TXOP time with the UHR AP.

The AP power save mode support field may be used to indicate whether the first device supports the AP power save function. In some embodiments, when the station is a UHR AP, a value of the AP power save mode support field being 1 indicates that the UHR AP can support the AP power save function; and the value of the AP power save mode support field being 0 indicates that the UHR AP cannot support the AP power save function. In some embodiments, when the station is a UHR AP, a value of the AP power save mode support field being 0 indicates that the UHR AP can support the AP power save function; and the value of the AP power save mode support field being 1 indicates that the UHR AP cannot support the AP power save function. When the first device is a UHR non-AP STA, the AP power save mode support field may be reserved.

The A-MPDU length adaptation support field may be used to indicate whether the first device supports the A-MPDU length passive adjustment function. In some embodiments, a value of the A-MPDU length adaptation support field being 1 may indicate that the first device can support the A-MPDU length passive adjustment function. The value of the A-MPDU length adaptation support field being 0 may indicate that the first device cannot support the A-MPDU length passive adjustment function. In some embodiments, a value of the A-MPDU length adaptation support field being 0 may indicate that the first device can support the A-MPDU length passive adjustment function. The value of the A-MPDU length adaptation support field being 1 may indicate that the first device cannot support the A-MPDU length passive adjustment function.

The 320 MHz frequency aggregation PPDU support field may be used to indicate whether the first device supports 320 MHz frequency aggregation PPDUs. In some embodiments, a value of the 320 MHz frequency aggregation PPDU support field being 1 may indicate that the first device can support transmission or reception of frequency aggregation PPDUs with a bandwidth of 320 MHz. The value of the 320 MHz frequency aggregation PPDU support field being 0 may indicate that the first device cannot support transmission or reception of frequency aggregation PPDUs with a bandwidth of 320 MHz. In some embodiments, a value of the 320 MHz frequency aggregation PPDU support field being 0 may indicate that the first device can support transmission or reception of frequency aggregation PPDUs with a bandwidth of 320 MHz. The value of the 320 MHz frequency aggregation PPDU support field being 1 may indicate that the first device cannot support transmission or reception of frequency aggregation PPDUs with a bandwidth of 320 MHz.

FIG. 7C is a schematic diagram of a format of the UHR PHY capabilities information field according to an embodiment of this application.

It may be seen from FIG. 7C that, the UHR PHY capabilities information field may include one or more of the following fields: a support for DRU (Bandwidth≤80 MHz) (support for DRU (BW≤80 MHz)) field, a support for DRU (Bandwidth=160 MHz) (support for DRU (BW=160 MHz)) field, a support for DRU (Bandwidth=320 MHz) (support for DRU (BW=320 MHz)) field, a support for EDRU (support for EDRU) field, a replication (Bandwidth≤80 MHz) (replication (BW≤80 MHz)) field, a replication (Bandwidth=160 MHz) (replication (BW=160 MHz)) field, a replication (Bandwidth=320 MHz) (replication (BW=320 MHz)) field, an RU adaptation field, a receive inserted PPDU support (rx inserted PPDU support) field, a transmit inserted PPDU support (tx inserted PPDU support) field, an auxiliary link above 45 GHz field, or a reserved field. These fields are described below separately.

The support for DRU (Bandwidth≤80 MHz) field may be used to indicate whether the first device supports transmission and/or reception of PPDUs with DRUs having a bandwidth less than or equal to 80 MHz. In some embodiments, a value of the support for DRU (Bandwidth≤80 MHz) field being 1 may indicate that the first device supports transmission and/or reception of PPDUs for a DRU with a bandwidth less than or equal to 80 MHz. The value of the support for DRU (Bandwidth≤80 MHz) field being 0 may indicate that the first device does not support transmission and/or reception of PPDUs for a DRU with a bandwidth less than or equal to 80 MHz. In some embodiments, a value of the support for DRU (Bandwidth≤80 MHz) field being 0 may indicate that the first device supports transmission and/or reception of PPDUs for a DRU with a bandwidth less than or equal to 80 MHz. The value of the support for DRU (Bandwidth≤80 MHz) field being 1 may indicate that the first device does not support transmission and/or reception of PPDUs for a DRU with a bandwidth less than or equal to 80 MHz.

The support for DRU (Bandwidth=160 MHz) field is used to indicate whether the first device supports transmission and/or reception of PPDUs for a DRU with a bandwidth equal to 160 MHz. In some embodiments, a value of the support for DRU (Bandwidth=160 MHz) field being 1 may indicate that the first device supports transmission and/or reception of PPDUs for a DRU with a bandwidth equal to 160 MHz. The value of the support for DRU (Bandwidth=160 MHz) field being 0 may indicate that the first device does not support transmission and/or reception of PPDUs for a DRU with a bandwidth equal to 160 MHz. In some embodiments, a value of the support for DRU (Bandwidth=160 MHz) field being 0 may indicate that the first device supports transmission and/or reception of PPDUs for a DRU with a bandwidth equal to 160 MHz. The value of the support for DRU (Bandwidth=160 MHz) field being 1 may indicate that the first device does not support transmission and/or reception of PPDUs for a DRU with a bandwidth equal to 160 MHz.

The support for DRU (Bandwidth=320 MHz) field is used to indicate whether the first device supports transmission and/or reception of PPDUs for a DRU with a bandwidth equal to 320 MHz. In some embodiments, a value of the support for DRU (Bandwidth=320 MHz) field being 1 may indicate that the first device supports transmission and/or reception of PPDUs for a DRU with a bandwidth equal to 320 MHz. The value of the support for DRU (Bandwidth=320 MHz) field being 0 may indicate that the first device does not support transmission and/or reception of PPDUs for a DRU with a bandwidth equal to 320 MHz. In some embodiments, a value of the support for DRU (Bandwidth=320 MHz) field being 0 may indicate that the first device supports transmission and/or reception of PPDUs for a DRU with a bandwidth equal to 320 MHz. The value of the support for DRU (Bandwidth=320 MHz) field being 1 may indicate that the first device does not support transmission and/or reception of PPDUs for a DRU with a bandwidth equal to 320 MHz.

The support for EDRU field is used to indicate whether the first device supports EDRU. In some embodiments, a value of the support for EDRU field being 1 may indicate support for transmission and/or reception of PPDUs for an enhanced DRU. The value of the support for EDRU field being 0 may indicate no support for transmission and/or reception of PPDUs for an enhanced DRU. In some embodiments, a value of the support for EDRU field being 0 may indicate support for transmission and/or reception of PPDUs for an enhanced DRU. The value of the support for EDRU field being 1 may indicate no support for transmission and/or reception of PPDUs for an enhanced DRU.

The replication (Bandwidth≤80 MHz) field may be used to indicate whether the first device supports the repetition function for a bandwidth less than or equal to 80 MHz. In some embodiments, a value of the replication (Bandwidth≤80 MHz) field being 1 may indicate that the first device supports transmission and/or reception of PPDUs that have a bandwidth less than or equal to 80 MHz and satisfy one or more of the following: frequency-domain replication, time-domain replication, or spatial-domain replication. The value of the replication (Bandwidth≤80 MHz) field being 0 may indicate that the first device does not support transmission and/or reception of PPDUs that have a bandwidth less than or equal to 80 MHz and satisfy one or more of the following: frequency-domain replication, time-domain replication, or spatial-domain replication. In some embodiments, a value of the replication (Bandwidth≤80 MHz) field being 0 may indicate that the first device supports transmission and/or reception of PPDUs that have a bandwidth less than or equal to 80 MHz and satisfy one or more of the following: frequency-domain replication, time-domain replication, or spatial-domain replication. The value of the replication (Bandwidth≤80 MHz) field being 1 may indicate that the first device does not support transmission and/or reception of PPDUs that have a bandwidth less than or equal to 80 MHz and satisfy one or more of the following: frequency-domain replication, time-domain replication, or spatial-domain replication.

The replication (Bandwidth=160 MHz) field may be used to indicate whether the first device supports the repetition function for a bandwidth equal to 160 MHz. In some embodiments, a value of the replication (Bandwidth=160 MHz) field being 1 may indicate that the first device supports transmission and/or reception of PPDUs that have a bandwidth equal to 160 MHz and satisfy one or more of the following: frequency-domain replication, time-domain replication, or spatial-domain replication. The value of the replication (Bandwidth=160 MHz) field being 0 may indicate that the first device does not support transmission and/or reception of PPDUs that have a bandwidth equal to 160 MHz and satisfy one or more of the following: frequency-domain replication, time-domain replication, or spatial-domain replication. In some embodiments, a value of the replication (Bandwidth=160 MHz) field being 0 may indicate that the first device supports transmission and/or reception of PPDUs that have a bandwidth equal to 160 MHz and satisfy one or more of the following: frequency-domain replication, time-domain replication, or spatial-domain replication. The value of the replication (Bandwidth=160 MHz) field being 1 may indicate that the first device does not support transmission and/or reception of PPDUs that have a bandwidth equal to 160 MHz and satisfy one or more of the following: frequency-domain replication, time-domain replication, or spatial-domain replication.

The replication (Bandwidth=320 MHz) field may be used to indicate whether the first device supports the repetition function for a bandwidth equal to 320 MHz. In some embodiments, a value of the replication (Bandwidth=320 MHz) field being 1 may indicate that the first device supports transmission and/or reception of PPDUs that have a bandwidth equal to 320 MHz and satisfy one or more of the following: frequency-domain replication, time-domain replication, or spatial-domain replication. The value of the replication (Bandwidth=320 MHz) field being 0 may indicate that the first device does not support transmission and/or reception of PPDUs that have a bandwidth equal to 320 MHz and satisfy one or more of the following: frequency-domain replication, time-domain replication, or spatial-domain replication. In some embodiments, a value of the replication (Bandwidth=320 MHz) field being 0 may indicate that the first device supports transmission and/or reception of PPDUs that have a bandwidth equal to 320 MHz and satisfy one or more of the following: frequency-domain replication, time-domain replication, or spatial-domain replication. The value of the replication (Bandwidth=320 MHz) field being 1 may indicate that the first device does not support transmission and/or reception of PPDUs that have a bandwidth equal to 320 MHz and satisfy one or more of the following: frequency-domain replication, time-domain replication, or spatial-domain replication.

The RU adaptation field is used to indicate whether the first device supports the RU adaptation function. In some embodiments, a value of the RU adaptation field being 1 may indicate support for transmission and/or reception of PPDUs with adaptive RUs (TB punctured PPDU). The value of the RU adaptation field being 0 may indicate no support for transmission and/or reception of PPDUs with adaptive RUs. In some embodiments, a value of the RU adaptation field being 0 may indicate support for transmission and/or reception of PPDUs with adaptive RUs. The value of the RU adaptation field being 1 may indicate no support for transmission and/or reception of PPDUs with adaptive RUs.

The receive inserted PPDU support field may be used to indicate whether the first device supports being a receiver in the inserted PPDU function. In some embodiments, a value of the receive inserted PPDU support field being 1 may indicate that the first device supports receiving inserted PPDUs. The value of the receive inserted PPDU support field being 0 may indicate that the first device does not support receiving inserted PPDUs. In some embodiments, a value of the receive inserted PPDU support field being 0 may indicate that the first device supports receiving inserted PPDUs. The value of the receive inserted PPDU support field being 1 may indicate that the first device does not support receiving inserted PPDUs.

The transmit inserted PPDU support field may be used to indicate whether the first device supports being a transmitter in the inserted PPDU function. In some embodiments, a value of the transmit inserted PPDU support field being 1 may indicate that the first device supports transmitting inserted PPDUs. The value of the transmit inserted PPDU support field being 0 may indicate that the first device does not support transmitting inserted PPDUs. In some embodiments, a value of the transmit inserted PPDU support field being 0 may indicate that the first device supports transmitting inserted PPDUs. The value of the transmit inserted PPDU support field being 1 may indicate that the first device does not support transmitting inserted PPDUs.

The auxiliary link above 45 GHz field may be used to indicate whether the first device supports transmission and reception in a frequency band above 45 GHz. In some embodiments, a value of the auxiliary link above 45 GHz field being 1 may indicate that there is an auxiliary link in a frequency band above 45 GHz, that is, the first device supports reception and/or transmission in a frequency band above 45 GHz. The value of the auxiliary link above 45 GHz field being 0 may indicate that there is no auxiliary link in a frequency band above 45 GHz, that is, the first device does not support reception and/or transmission in a frequency band above 45 GHz. In some embodiments, a value of the auxiliary link above 45 GHz field being 0 may indicate that there is an auxiliary link in a frequency band above 45 GHz. The value of the auxiliary link above 45 GHz field being 1 may indicate that there is no auxiliary link in a frequency band above 45 GHz.

The first capabilities element may be included in one or more of the following frames: a beacon frame, an association request frame, an association response frame, a reassociation request frame, a reassociation response frame, a probe request frame, or a probe response frame. In other words, the capabilities information indicated in the first capabilities element may be transmitted to a peer device through the capability discovery process described above.

As mentioned above, the target device may include the third device. In other words, the first device may indicate capabilities information of other devices through the first indication information. In a case in which the target device includes the third device, the first indication information may be included in a neighbor report element and/or a reduced neighbor report element.

In a case in which the first indication information is included in the neighbor report element, the third device may correspond to an AP indicated by a BSSID field in the element, namely, an AP reported by the element (hereinafter referred to as a reported AP).

In some embodiments, the neighbor report element may be used to indicate one or more of the following information of the third device: whether a target protocol is supported; whether multi-AP coordination is supported; whether communication in a frequency band above 45 GHz is supported; whether secondary channel access is supported; whether transmission based on a distributed RU is supported; whether the device is a mobile AP; or a power supply mode. Descriptions of the foregoing information are detailed earlier and will not be repeated here.

For example, the first device may be an AP, and the second device may be a non-AP STA. The AP may notify, through the neighbor report element, the non-AP STA of information about other APs near the AP, thereby helping the non-AP STA learn surrounding APs. Compared to the related technologies, capabilities information of neighbor APs included in the neighbor report element is more comprehensive, which facilitates the non-AP STA in performing more accurate and efficient handover.

FIG. 8 is a schematic diagram of a format of the neighbor report element according to an embodiment of this application.

As shown in FIG. 8, the BSSID information field may include one or more of the following fields: an ultra high reliability field, a multi-AP coordination field, a colocated with above 45 GHz field, a secondary channel field, a mobile AP field, a power source field, a DRU field, or a reserved field.

The ultra high reliability field may be used to indicate whether the reported AP supports the target protocol (the target protocol being UHR is used as an example in FIG. 8), that is, whether the AP is a UHR AP. In addition, the ultra high reliability field may indicate whether content of a UHR capabilities element (or a UHR operation element) (if included as a subelement in the report) is the same as content of a UHR capabilities element (or a UHR operation element) included in a beacon frame transmitted by the reported AP.

In some embodiments, the ultra high reliability field being set to 1 may indicate that the reported AP supports UHR, and that the content of the UHR capabilities element (or the UHR operation element) (if included as a subelement in the report) is the same as the content of the UHR capabilities element (or the UHR operation element) included in the beacon frame transmitted by the reported AP. The ultra high reliability field being set to 0 may indicate that the reported AP does not support UHR, or that the content of the UHR capabilities element (or the UHR operation element) (if included as a subelement in the report) is the same as the content of the UHR capabilities element (or the UHR operation element) included in the beacon frame transmitted by the reported AP. In some embodiments, the ultra high reliability field being set to 0 may indicate that the reported AP supports UHR, and that the content of the UHR capabilities element (or the UHR operation element) (if included as a subelement in the report) is the same as the content of the UHR capabilities element (or the UHR operation element) included in the beacon frame transmitted by the reported AP. The ultra high reliability field being set to 1 may indicate that the reported AP does not support UHR, or that the content of the UHR capabilities element (or the UHR operation element) (if included as a subelement in the report) is different from the content of the UHR capabilities element (or the UHR operation element) included in the beacon frame transmitted by the reported AP.

The multi-AP coordination field may be used to indicate whether the reported AP supports multi-AP coordination. The multi-AP coordination field may also indicate whether content of a multi-AP element (if included as a subelement in the report) is the same as content of a multi-AP element included in a beacon frame transmitted by the reported AP.

In some embodiments, the multi-AP coordination field being set to 1 may indicate that the reported AP has a multi-AP coordination capability, and that the content of the multi-AP element (if included as a subelement in the report) is the same as the content of the multi-AP element included in the beacon frame transmitted by the reported AP. The multi-AP coordination field being set to 0 may indicate that the reported AP does not have a multi-AP coordination capability, or that the content of the multi-AP element (if included as a subelement in the report) is different from the content of the multi-AP element included in the beacon frame transmitted by the reported AP. In some embodiments, the multi-AP coordination field being set to 0 may indicate that the reported AP has a multi-AP coordination capability, and that the content of the multi-AP element (if included as a subelement in the report) is the same as the content of the multi-AP element included in the beacon frame transmitted by the reported AP. The multi-AP coordination field being set to 1 may indicate that the reported AP does not have a multi-AP coordination capability, or that the content of the multi-AP element (if included as a subelement in the report) is different from the content of the multi-AP element included in the beacon frame transmitted by the reported AP.

The colocated with above 45 GHz field may be used to indicate whether the reported AP supports communication in a frequency band above 45 GHz. In other words, the colocated with above 45 GHz field may be used to indicate whether the reported AP is located in a same colocated AP set as an AP operating in a frequency band above 45 GHz.

In some embodiments, the colocated with above 45 GHz field being set to 1 may indicate that the reported AP is located in the same colocated AP set as the AP operating in the frequency band above 45 GHz. The colocated with above 45 GHz field being set to 0 may indicate that the reported AP is not located in the same colocated AP set as the AP operating in the frequency band above 45 GHz. In some embodiments, the colocated with above 45 GHz field being set to 0 may indicate that the reported AP is located in the same colocated AP set as the AP operating in the frequency band above 45 GHz. The colocated with above 45 GHz field being set to 1 may indicate that the reported AP is not located in the same colocated AP set as the AP operating in the frequency band above 45 GHZ.

The secondary channel field may be used to indicate whether the reported AP supports secondary channel access. In addition, the secondary channel field may further indicate whether content of a secondary channel operation element (if included as a subelement in the report) is the same as content of a secondary channel operation element included a beacon frame transmitted by the reported AP.

In some embodiments, the secondary channel field being set to 1 may indicate that the reported AP can perform secondary channel access, and that the content of the secondary channel operation element (if included as a subelement in the report) is the same as the content of the secondary channel operation element included the beacon frame transmitted by the reported AP. The secondary channel field being set to 0 may indicate that the reported AP cannot perform secondary channel access, or that the content of the secondary channel operation element (if included as a subelement in the report) is different from the content of the secondary channel operation element included the beacon frame transmitted by the reported AP. In some embodiments, the secondary channel field being set to 0 may indicate that the reported AP can perform secondary channel access, and that the content of the secondary channel operation element (if included as a subelement in the report) is the same as the content of the secondary channel operation element included the beacon frame transmitted by the reported AP. The secondary channel field being set to 1 may indicate that the reported AP cannot perform secondary channel access, or that the content of the secondary channel operation element (if included as a subelement in the report) is different from the content of the secondary channel operation element included the beacon frame transmitted by the reported AP.

The mobile AP field may be used to indicate whether the reported AP is a mobile AP. In some embodiments, the mobile AP field being set to 1 may indicate that the reported AP is a mobile AP. The mobile AP field being set to 0 may indicate that the reported AP is not a mobile AP. In some embodiments, the mobile AP field being set to 0 may indicate that the reported AP is a mobile AP. The mobile AP field being set to 1 may indicate that the reported AP is not a mobile AP.

The power source field may be used to indicate a power supply mode of the reported AP. For example, the power source field may indicate whether the reported AP is powered solely by a battery. In some embodiments, the power source field being set to 1 may indicate that the reported AP is powered solely by a battery. The power source field being set to 0 may indicate that the reported AP is not powered solely by a battery. In some embodiments, the power source field being set to 0 may indicate that the reported AP is powered solely by a battery. The power source field being set to 1 may indicate that the reported AP is not powered solely by a battery.

The DRU field may be used to indicate whether the reported AP supports DRU-based transmission. In some embodiments, the DRU field being set to 1 may indicate that the reported AP supports transmission and/or reception of UHR PPDUs containing a DRU. The DRU field being set to 0 may indicate that the reported AP does not support transmission and/or reception of UHR PPDUs containing a DRU. In some embodiments, the DRU field being set to 0 may indicate that the reported AP supports transmission and/or reception of UHR PPDUs containing a DRU. The DRU field being set to 1 may indicate that the reported AP does not support transmission and/or reception of UHR PPDUs containing a DRU.

As shown in FIG. 8, the neighbor report element may further include other fields. The BSSID information field may also include other fields. The other fields may have the same functions as the fields in the related technologies, and details are not repeated herein.

In some embodiments, the neighbor report element may be included in one or more of the following frames: a beacon frame, an association response frame, a reassociation response frame, or an identity authentication frame.

In a case in which the first indication information is included in the reduced neighbor report element, the first device may be an AP, and the second device may be a non-AP STA. The AP may notify, through the reduced neighbor report element, the non-AP STA of information related to beacon frames broadcast by another nearby AP (that is, the target device), thereby helping the non-AP STA quickly scan for other APs.

In a case in which the first indication information is included in the reduced neighbor report element, the reduced neighbor report element may be used to indicate whether the third device supports one or more of the following: broadcasting a beacon frame on a secondary channel; receiving a probe request frame on a secondary channel; or replying with a probe response frame on a secondary channel.

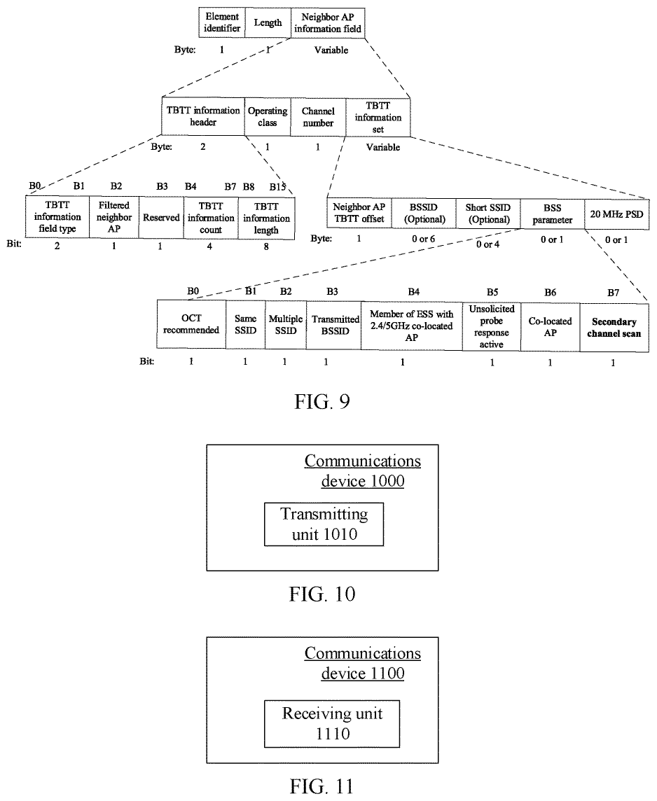

FIG. 9 is a schematic diagram of a format of the reduced neighbor report element according to an embodiment of this application.

As shown in FIG. 9, the reduced neighbor report element may include a secondary channel scan field.

The secondary channel scan field may be used to indicate whether the third device supports one or more of the following: broadcasting a beacon frame on a secondary channel, receiving a probe request frame on a secondary channel, or replying with a probe response frame on a secondary channel.

In some embodiments, the secondary channel scan field being set to 1 may indicate that the reported AP broadcasts a beacon frame on a secondary channel, and/or the reported AP receives a probe request frame and replies with a probe response frame on the secondary channel. The secondary channel scan field being set to 0 may indicate that the reported AP broadcasts no beacon frame on a secondary channel, and/or the reported AP does not receive any probe request frame or reply with any probe response frame on the secondary channel. In some embodiments, the secondary channel scan field being set to 0 may indicate that the reported AP broadcasts a beacon frame on a secondary channel, and/or the reported AP receives a probe request frame and replies with a probe response frame on the secondary channel. The secondary channel scan field being set to 1 may indicate that the reported AP broadcasts no beacon frame on a secondary channel, and/or the reported AP does not receive any probe request frame or reply with any probe response frame on the secondary channel.

The reduced neighbor report element may be included in one or more of the following frames: a beacon frame, or a probe response frame.

It should be noted that the names (including but not limited to field names, element names, frame names, and the like) in embodiments of this application are merely examples. In other words, the names in this application may all be modified or replaced.

It should be noted that the positions, presence, and lengths of fields included in the fields, elements, frames, and the like in the embodiments are merely examples, and are not limited in this application.

The foregoing describes the method embodiments of this application in detail. The following describes apparatus embodiments of this application in detail. It should be understood that the descriptions of the method embodiments correspond to descriptions of the apparatus embodiments, and therefore, for parts that are not described in detail, reference may be made to the foregoing method embodiments.

FIG. 10 is a schematic diagram of a structure of a communications device 1000 according to an embodiment of this application. The communications device 1000 may be a first device. The communications device 1000 may include a transmitting unit 1010.

The transmitting unit 1010 is configured to transmit first indication information to a second device, where the first indication information is used to indicate capabilities information of a target device, the target device includes the first device and/or a third device, and the capabilities information includes one or more of following information of the target device: a capability of multi-AP coordination; a capability of secondary channel access; a capability of priority channel access; a support status of a link adaptation function; a support status of a relay function; a capability of transmission based on a DRU; a mobility capability; a power supply mode; a capability related to preemption; a capability to support a target protocol; a capability of enhanced roaming; a support status of a TXOP sharing function based on a non-triggered frame; a power-saving capability; a support status of an A-MPDU length passive adjustment function; a support status of a 320 MHz frequency aggregation PPDU; a support status of an RU adaptation function; a support status of a replication function; a capability of inserted PPDU-based communication; or a capability of communication in a frequency band above 45 GHz.

In an optional embodiment, the transmitting unit 1010 may be a transceiver 1230. The communications device 1000 may further include a processor 1210 and a memory 1220, which are specifically shown in FIG. 12.

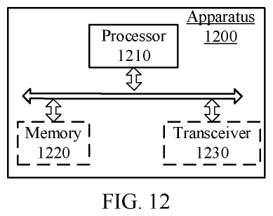

FIG. 11 is a schematic diagram of a structure of a communications device 1100 according to an embodiment of this application. The communications device 1100 may be a second device. The communications device 1100 may include a receiving unit 1110.

The receiving unit 1110 may be configured to receive first indication information transmitted by a first device, where the first indication information is used to indicate capabilities information of a target device, the target device includes the first device and/or a third device, and the capabilities information includes one or more of following information of the target device: a capability of multi-AP coordination; a capability of secondary channel access; a capability of priority channel access; a support status of a link adaptation function; a support status of a relay function; a capability of transmission based on a DRU; a mobility capability; a power supply mode; a capability related to preemption; a capability to support a target protocol; a capability of enhanced roaming; a support status of a TXOP sharing function based on a non-triggered frame; a power-saving capability; a support status of an A-MPDU length passive adjustment function; a support status of a 320 MHz frequency aggregation PPDU; a support status of an RU adaptation function; a support status of a replication function; a capability of inserted PPDU-based communication; or a capability of communication in a frequency band above 45 GHz.

In an optional embodiment, the receiving unit 1110 may be a transceiver 1230. The communications device 1100 may further include a processor 1210 and a memory 1220, which are specifically shown in FIG. 12.

FIG. 12 is a schematic structural diagram of an apparatus for communication according to an embodiment of this application. Dashed lines in FIG. 12 indicate that a unit or module is optional. The apparatus 1200 may be configured to implement the methods described in the foregoing method embodiments. The apparatus 1200 may be a chip or a communications device.

The apparatus 1200 may include one or more processors 1210. The processor 1210 may support the apparatus 1200 in implementing the methods described in the foregoing method embodiments. The processor 1210 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1200 may further include one or more memories 1220. The memory 1220 stores a program, where the program may be executed by the processor 1210, to cause the processor 1210 to execute the methods described in the method embodiments. The memory 1220 may be separate from or integrated into the processor 1210.

The apparatus 1200 may further include a transceiver 1230. The processor 1210 may communicate with another device or chip by using the transceiver 1230. For example, the processor 1210 may transmit data to and receive data from another device or chip through the transceiver 1230.

An embodiment of this application further provides a computer-readable storage medium for storing a program. The computer-readable storage medium may be applied to the communications device provided in embodiments of this application, and the program causes a computer to perform the methods performed by the communications device in various embodiments of this application.

An embodiment of this application further provides a computer program product. The computer program product includes a program. The computer program product may be applied to the communications device provided in embodiments of this application, and the program causes a computer to perform the methods performed by the communications device in various embodiments of this application.

An embodiment of this application further provides a computer program. The computer program may be applied to the communications device provided in embodiments of this application, and the computer program causes a computer to execute the methods executed by the communications device in embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In this embodiment of this application, a “field” may also be referred to as a “domain (field)”, a “subdomain (subfield)”, or a “subfield”. One field may occupy one or more bytes (byte/octet), or one field may occupy one or more bits.

In embodiments of this application, “indication” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “pre-configured” may be implemented by prestoring corresponding code, tables, or other forms that may be used to indicate related information in devices (for example, including an AP and an STA), and a specific implementation thereof is not limited in this application. For example, being predefined may refer to being defined in a protocol.

In embodiments of this application, the term “and/or” describes merely an association relationship between associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, the “include” may refer to direct inclusion, or may refer to indirect inclusion. Optionally, the term “include” mentioned in embodiments of this application may be replaced with “indicate” or “be used to determine”. For example, A including B may be replaced with that A indicates B, or A is used to determine B.

In embodiments of this application, sequence numbers of the foregoing processes do not mean execution orders. The execution orders of the processes should be determined based on functions and internal logic of the processes, and should not be construed as any limitation on the implementation processes of embodiments of this application.

In embodiments of this application, the “protocol” may refer to a standard protocol in the communications field, and may include, for example, a WiFi protocol, and a related protocol applied to a future WiFi communications system, which is not limited in this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
transmitting, by a first device, first indication information to a second device,
wherein the first indication information is used to indicate capabilities information of a target device, the target device comprises the first device and/or a third device, and the capabilities information comprises one or more of following information of the target device: a capability of multi-access point (AP) coordination; a capability of secondary channel access; a capability of priority channel access; a support status of a link adaptation function; a support status of a relay function; a capability of transmission based on a distributed resource unit (DRU); a mobility capability; a power supply mode; a capability related to preemption; a capability to support a target protocol; a capability of enhanced roaming; a support status of a transmission opportunity (TXOP) sharing function based on a non-triggered frame; a power-saving capability; a support status of an aggregation medium access control protocol data unit (A-MPDU) length passive adjustment function; a support status of a 320 MHz frequency aggregation physical layer protocol data unit (PPDU); a support status of a resource unit (RU) adaptation function; a support status of a replication function; a capability of inserted PPDU-based communication; or a capability of communication in a frequency band above 45 GHz.

2. The method according to claim 1, wherein the capability of secondary channel access comprises one or more of following capabilities of the target device:
whether a secondary channel access function is supported;
a physical layer version of a supported secondary channel access function;
a quantity of secondary channels supported for access;
information about a first secondary channel supported for access;
power-saving information for performing secondary channel access;
a channel switch delay;
a secondary channel suggested for use;
a capability to transmit or receive a PPDU on a secondary channel;
whether it is possible to broadcast a beacon frame on a secondary channel;
whether it is possible to receive a probe request frame on a secondary channel; or
whether it is possible to reply with a probe response frame on a secondary channel.

3. The method according to claim 1, wherein in a case in which the target device comprises the third device, the first indication information is comprised in a neighbor report element and/or a reduced neighbor report element.

4. The method according to claim 3, wherein in a case in which the first indication information is comprised in the neighbor report element, the neighbor report element is used to indicate one or more of following information of the third device:
whether a target protocol is supported;
whether multi-AP coordination is supported;
whether communication in a frequency band above 45 GHz is supported;
whether secondary channel access is supported;
whether transmission based on a distributed RU is supported;
whether the device is a mobile AP; or
a power supply mode.

5. The method according to claim 1, wherein in a case in which the target device comprises the first device, the first indication information is comprised in a first capabilities element.

6. The method according to claim 5, wherein the first capabilities element is used to indicate whether the first device supports one or more of following:
a multi-AP coordination function;
a secondary channel access function;
an initiator in a preemption function;
a responder in a preemption function;
a priority channel access function;
a link adaptation function;
a relay function;
an enhanced roaming function;
a TXOP sharing function based on a non-triggered frame;
an AP power save function;
an A-MPDU length passive adjustment function;
a 320 MHz frequency aggregation PPDU;
a distributed RU;
an enhanced distributed RU;
an RU adaptation function;
a replication function;
a receiver in an inserted PPDU function;
a transmitter in an inserted PPDU function; or
transmission and reception in a frequency band above 45 GHz.

7. The method according to claim 5, wherein the first capabilities element is comprised in one or more of following frames: a beacon frame, an association request frame, an association response frame, a reassociation request frame, a reassociation response frame, a probe request frame, or a probe response frame.

8. A wireless communication method, comprising:
receiving, by a second device, first indication information transmitted by a first device,
wherein the first indication information is used to indicate capabilities information of a target device, the target device comprises the first device and/or a third device, and the capabilities information comprises one or more of following information of the target device: a capability of multi-access point AP coordination; a capability of secondary channel access; a capability of priority channel access; a support status of a link adaptation function; a support status of a relay function; a capability of transmission based on a distributed resource unit (DRU); a mobility capability; a power supply mode; a capability related to preemption; a capability to support a target protocol; a capability of enhanced roaming; a support status of a transmission opportunity (TXOP) sharing function based on a non-triggered frame; a power-saving capability; a support status of an aggregation medium access control protocol data unit (A-MPDU) length passive adjustment function; a support status of a 320 MHz frequency aggregation physical layer protocol data unit (PPDU); a support status of a resource unit (RU) adaptation function; a support status of a replication function; a capability of inserted PPDU-based communication; or a capability of communication in a frequency band above 45 GHz.

9. The method according to claim 8, wherein the capability of secondary channel access comprises one or more of following capabilities of the target device:
whether a secondary channel access function is supported;
a physical layer version of a supported secondary channel access function;
a quantity of secondary channels supported for access;
information about a first secondary channel supported for access;
power-saving information for performing secondary channel access;
a channel switch delay;
a secondary channel suggested for use;
a capability to transmit or receive a PPDU on a secondary channel;
whether it is possible to broadcast a beacon frame on a secondary channel;
whether it is possible to receive a probe request frame on a secondary channel; or
whether it is possible to reply with a probe response frame on a secondary channel.

10. The method according to claim 8, wherein in a case in which the target device comprises the third device, the first indication information is comprised in a neighbor report element and/or a reduced neighbor report element.

11. The method according to claim 10, wherein in a case in which the first indication information is comprised in the neighbor report element, the neighbor report element is used to indicate one or more of following information of the third device:
whether a target protocol is supported;
whether multi-AP coordination is supported;
whether communication in a frequency band above 45 GHz is supported;
whether secondary channel access is supported;
whether transmission based on a distributed RU is supported;
whether the device is a mobile AP; or
a power supply mode.

12. The method according to claim 8, wherein in a case in which the target device comprises the first device, the first indication information is comprised in a first capabilities element.

13. The method according to claim 12, wherein the first capabilities element is used to indicate whether the first device supports one or more of following:
a multi-AP coordination function;
a secondary channel access function;
an initiator in a preemption function;
a responder in a preemption function;
a priority channel access function;
a link adaptation function;
a relay function;
an enhanced roaming function;
a TXOP sharing function based on a non-triggered frame;
an AP power save function;
an A-MPDU length passive adjustment function;
a 320 MHz frequency aggregation PPDU;
a distributed RU;
an enhanced distributed RU;
an RU adaptation function;
a replication function;
a receiver in an inserted PPDU function;
a transmitter in an inserted PPDU function; or
transmission and reception in a frequency band above 45 GHz.

14. The method according to claim 12, wherein the first capabilities element is comprised in one or more of following frames: a beacon frame, an association request frame, an association response frame, a reassociation request frame, a reassociation response frame, a probe request frame, or a probe response frame.

15. A communications device, comprising a memory and a processor, wherein the memory is configured to store a program, and the processor is configured to invoke the program in the memory to cause the communications device to execute the following operation:
receiving first indication information transmitted by a first device,
wherein the first indication information is used to indicate capabilities information of a target device, the target device comprises the first device and/or a third device, and the capabilities information comprises one or more of following information of the target device: a capability of multi-access point (AP) coordination; a capability of secondary channel access; a capability of priority channel access; a support status of a link adaptation function; a support status of a relay function; a capability of transmission based on a distributed resource unit (DRU); a mobility capability; a power supply mode; a capability related to preemption; a capability to support a target protocol; a capability of enhanced roaming; a support status of a transmission opportunity (TXOP) sharing function based on a non-triggered frame; a power-saving capability; a support status of an aggregation medium access control protocol data unit (A-MPDU) length passive adjustment function; a support status of a 320 MHz frequency aggregation physical layer protocol data unit (PPDU); a support status of a resource unit (RU) adaptation function; a support status of a replication function; a capability of inserted PPDU-based communication; or a capability of communication in a frequency band above 45 GHz.

16. The communications device according to claim 15, wherein the capability of secondary channel access comprises one or more of following capabilities of the target device:
whether a secondary channel access function is supported;
a physical layer version of a supported secondary channel access function;
a quantity of secondary channels supported for access;
information about a first secondary channel supported for access;
power-saving information for performing secondary channel access;
a channel switch delay;
a secondary channel suggested for use;
a capability to transmit or receive a PPDU on a secondary channel;
whether it is possible to broadcast a beacon frame on a secondary channel;
whether it is possible to receive a probe request frame on a secondary channel; or
whether it is possible to reply with a probe response frame on a secondary channel.

17. The communications device according to claim 15, wherein in a case in which the target device comprises the third device, the first indication information is comprised in a neighbor report element and/or a reduced neighbor report element.

18. The communications device according to claim 17, in a case in which the first indication information is comprised in the neighbor report element, the neighbor report element is used to indicate one or more of following information of the third device:
whether a target protocol is supported;
whether multi-AP coordination is supported;
whether communication in a frequency band above 45 GHz is supported;
whether secondary channel access is supported;
whether transmission based on a distributed RU is supported;
whether the device is a mobile AP; or
a power supply mode.

19. The communications device according to claim 15, in a case in which the target device comprises the first device, the first indication information is comprised in a first capabilities element.

20. The communications device according to claim 19, wherein the first capabilities element is used to indicate whether the first device supports one or more of following:
a multi-AP coordination function;
a secondary channel access function;
an initiator in a preemption function;
a responder in a preemption function;
a priority channel access function;
a link adaptation function;
a relay function;
an enhanced roaming function;
a TXOP sharing function based on a non-triggered frame;
an AP power save function;
an A-MPDU length passive adjustment function;
a 320 MHz frequency aggregation PPDU;
a distributed RU;
an enhanced distributed RU;
an RU adaptation function;
a replication function;
a receiver in an inserted PPDU function;
a transmitter in an inserted PPDU function; or
transmission and reception in a frequency band above 45 GHz.
